(19) United States
(12) Patent Application Publication
(10) Pub. No.: US 2014/0146278 A1
(43) Pub. Date: May 29, 2014

(54) NANO CRYSTAL DISPLAY DEVICE HAVING IMPROVED MICROCAVITY STRUCTURE

(71) Applicant: Samsung Display Co., Ltd., Yongin City (KR)

(72) Inventors: Hee-Keun LEE, Suwon-si (KR); Hae Ju YUN, Hwaseong-si (KR); Jung Wook LEE, Uiwang-si (KR); Seon Uk LEE, Seongnam-si (KR); Dong Hwan KIM, Hwaseong-si (KR); Sung Jun KIM, Hwaseong-si (KR); Yeun Tae KIM, Suwon-si (KR); Hyoung Sub LEE, Hwaseong-si (KR); Sung Woo CHO, Suwon-si (KR); Tae Woon CHA, Seoul (KR); Sang Gun CHOI, Suwon-si (KR)

(73) Assignee: Samsung Display Co., Ltd., Yongin City (KR)

(21) Appl. No.: 13/962,833

(22) Filed: Aug. 8, 2013

(30) Foreign Application Priority Data
Nov. 23, 2012 (KR) 10-2012-0133898

(51) Int. Cl. G02F 1/1335

(52) U.S. Cl. CPC G02F 1/133512
USPC 349/110; 349/139; 445/24

(57) ABSTRACT

A display panel with microcavities each having ends of asymmetric cross-sectional area. An exemplary display panel has a substrate; an electrode disposed on the substrate; and a supporting member disposed on the electrode. The supporting member is shaped to form a cavity between the supporting member and the electrode. The cavity has a first opening at one end of the supporting member and a second opening at an opposite end of the supporting member, the first opening being positioned over the electrode. A cross-sectional area of the first opening is smaller than a cross-sectional area of the second opening.

### CROSS-REFERENCE TO RELATED APPLICATION

This application claims priority to, and the benefit of, Korean Patent Application No. 10-2012-0133898 filed in the Korean Intellectual Property Office on Nov. 23, 2012, the entire contents of which are incorporated herein by reference.

### BACKGROUND

(a) Field

Embodiments of the present invention relate generally to flat panel displays and methods of their manufacture. More specifically, embodiments of the present invention relate to displays having improved microcavity structures, and their manufacture.

(b) Description of the Related Art

A liquid crystal display is one type of flat panel display devices that has found wide acceptance, and commonly includes two display panels where field generating electrodes such as a pixel electrode and a common electrode are formed, with a liquid crystal layer interposed therebetween. The liquid crystal display generates an electric field in the liquid crystal layer by applying voltages to the field generating electrodes, thus inducing specific orientations of liquid crystal molecules of the liquid crystal layer and thusly controlling the polarization of incident light, thereby displaying an image.

Liquid crystal displays having an NCD (Nano Crystal Display) structure that employs a sacrificial layer formed of an organic material. A supporting member is coated thereon, then the sacrificial layer is removed, and a liquid crystal is filled in the empty space formed by removal of the sacrificial layer.

A method of manufacturing liquid crystal displays having an NCD structure also includes a process of injecting and drying an aligning agent before injecting the liquid crystal to arrange and align the liquid crystal molecules. In the process of drying the aligning agent, evaporation of the aligning agent may result in deposits of aligning agent solids such that light leakage or transmittance deterioration may be generated.

The above information disclosed in this Background section is only for enhancement of understanding of the background of the invention and therefore it may contain information that does not form the prior art that is already known in this country to a person of ordinary skill in the art.

### SUMMARY

The present invention provides a liquid crystal display minimizing an agglomeration of a solid, and a manufacturing method thereof. According to an exemplary embodiment of the present invention, by controlling a height of a microcavity layer corresponding to a liquid crystal injection hole, the agglomeration of the solid generated when drying the aligning agent may not be recognized.

According to an embodiment of the inventive concept, a display panel is provided, The display panel includes a substrate; an electrode disposed on the substrate; and a supporting member disposed on the electrode; the supporting member shaped to form a cavity between the supporting member and the electrode, wherein the cavity has a first opening at one end of the supporting member and a second opening at an opposite end of the supporting member, the first opening being positioned over the electrode; and wherein a cross-sectional area of the first opening is smaller than a cross-sectional area of the second opening.

According to another embodiment of the inventive concept, a display panel is provided. The display panel includes a substrate; an electrode disposed on the substrate; and a supporting member disposed on the electrode, the supporting member shaped to form a cavity between the supporting member and the electrode; wherein the supporting member has a first portion positioned proximate to one end of the cavity and a second portion positioned at a central portion of the cavity; and wherein the first portion is positioned at a first distance from the electrode, and the second portion is positioned at a second distance from the electrode, the second distance being greater than the first distance.

According to another embodiment of the inventive concept, a method of manufacturing a display panel is provided. The method of manufacturing a display panel includes forming an electrode on a substrate; forming a sacrificial layer on the electrode; patterning a depression in the sacrificial layer; forming a supporting member on the sacrificial layer and the depression; removing a portion of the supporting member that is positioned on the depression, so as to form a groove exposing the sacrificial layer; and removing the sacrificial layer through the groove, so as to form a cavity between the supporting member and the electrode, the cavity configured to hold a liquid therein.

According to another embodiment of the inventive concept, a display panel is provided. The display panel includes a substrate; a first electrode disposed on the substrate; a black matrix formed on the substrate; and a supporting member disposed on the substrate over the first electrode and the black matrix, the supporting member shaped to form a cavity between the pixel electrode and the supporting member, the cavity having a narrow portion positioned over the black matrix, the narrow portion having a smaller cross-sectional area than a remainder of the cavity.

### BRIEF DESCRIPTION OF THE DRAWINGS

FIG. 1 is a top plan view of a liquid crystal display according to an exemplary embodiment of the present invention.

FIG. 2 is a cross-sectional view taken along a line II-II of FIG. 1.

FIG. 3 and FIG. 4 are cross-sectional views taken along a line III-III of FIG. 1.

FIG. 5 is a perspective view of a microcavity layer according to the exemplary embodiment of FIG. 1 to FIG. 4.

FIG. 6 to FIG. 12 are cross-sectional views of a manufacturing method of a liquid crystal display according to another exemplary embodiment of the present invention.

FIG. 13 is a top plan view viewing a liquid crystal display according to an exemplary embodiment of the present invention from a position P to a position Q of FIG. 3 for explanation.

FIG. 14 and FIG. 15 are top plan views to schematically explain a liquid crystal display according to an exemplary embodiment of the present invention.

FIG. 16 and FIG. 17 are cross-sectional views taken along the line III-III of FIG. 1 to explain a liquid crystal display according to an exemplary embodiment of the present invention.

FIG. 18 to FIG. 25 are cross-sectional views of a manufacturing method of a liquid crystal display according to another exemplary embodiment of the present invention.

FIG. 26 is a cross-sectional view taken along the line III-III of FIG. 1 to explain a liquid crystal display according to an exemplary embodiment of the present invention.

FIG. 27 is a top plan view viewing a liquid crystal display according to an exemplary embodiment of the present invention from a position P to a position Q of FIG. 16 for explanation.

FIG. 28 and FIG. 29 are top plan views to schematically explain a liquid crystal display according to an exemplary embodiment of the present invention.

FIG. 30 is a perspective view of a microcavity layer shape to explain a liquid crystal display according to an exemplary embodiment.

FIG. 31 is a cross-sectional view of a liquid crystal display according to an exemplary embodiment of the present invention.

FIG. 32 is a cross-sectional view of a liquid crystal display according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. However, the present invention is not limited to the exemplary embodiments described herein, and may be embodied in other forms. Rather, exemplary embodiments described herein are provided to thoroughly and completely explain the disclosed contents and to sufficiently transfer the ideas of the present invention to a person of ordinary skill in the art. In the drawings, the thicknesses of layers and regions, as well as other dimensions, are exaggerated for clarity. It is to be noted that when a layer is referred to as being “on” another layer or substrate, it can be directly formed on the other layer or substrate or can be formed on the other layer or substrate with a third layer interposed therebetween. Like constituent elements are denoted by like reference numerals throughout the specification.

Embodiments of the invention relate to a display such as a liquid crystal display, where the display panel has a single substrate that holds both the pixel electrode and the common electrode, as well as a liquid crystal layer injected therebetween. The liquid crystal is held in a number of microcavities, each of which has openings for injection of the liquid crystal. The openings of each microcavity are asymmetric, in that one opening has a larger cross-sectional area than the other. This asymmetry in opening sizes confers advantages during the process of fabricating the display panel. In particular, prior to injecting liquid crystal, aligning agent is injected into the microcavities through the opening and then dried. The drying process leaves solids from the aligning agent in the microcavities, and when the microcavity openings are of differing sizes, the solids tend to accumulate at one of the openings, rather than in the center of the cavity where they can block light. By accumulating aligning agent solids at the openings, which are covered by black matrices anyway, undesired light-blocking deposits are prevented, resulting in improved image display quality. Multiple different configurations of such asymmetric microcavity openings are contemplated, any of which can be used in any combination or combinations.

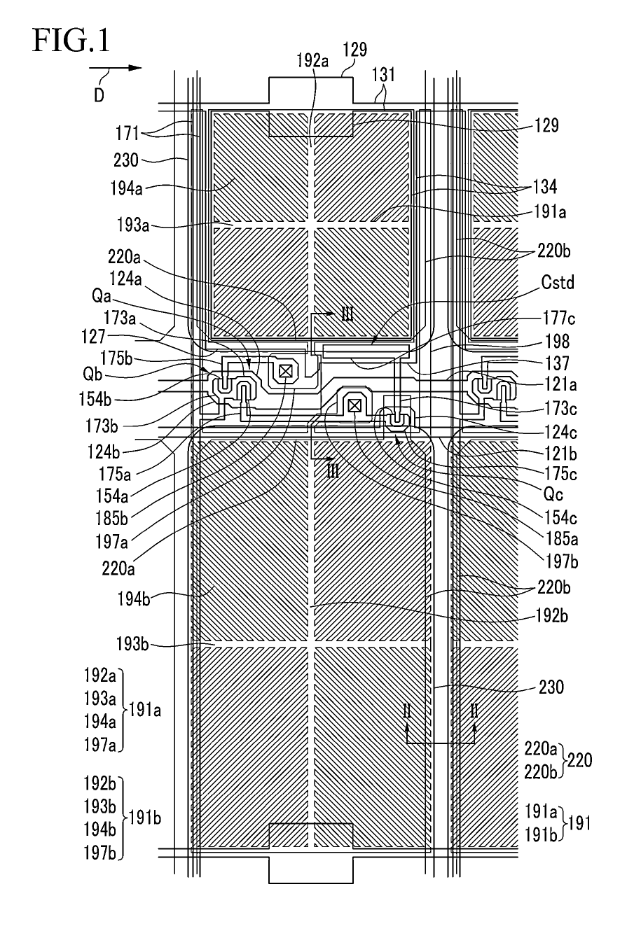

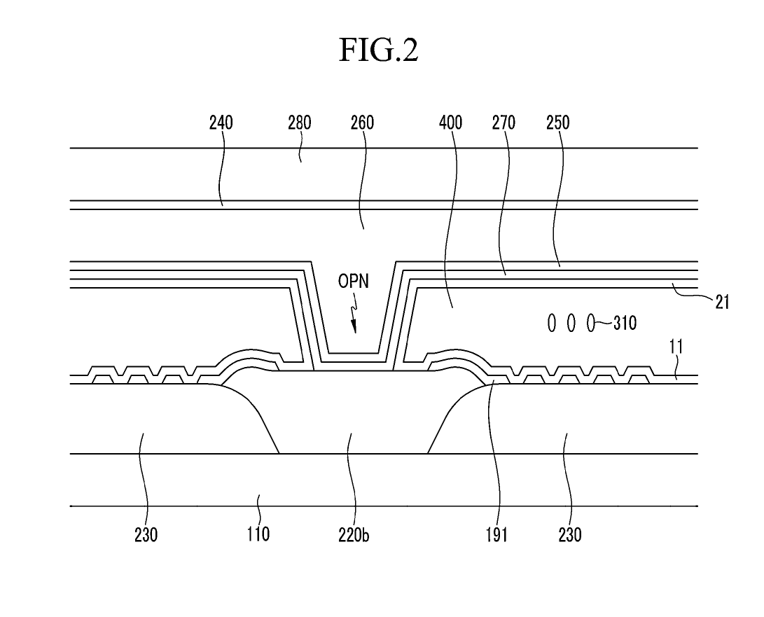

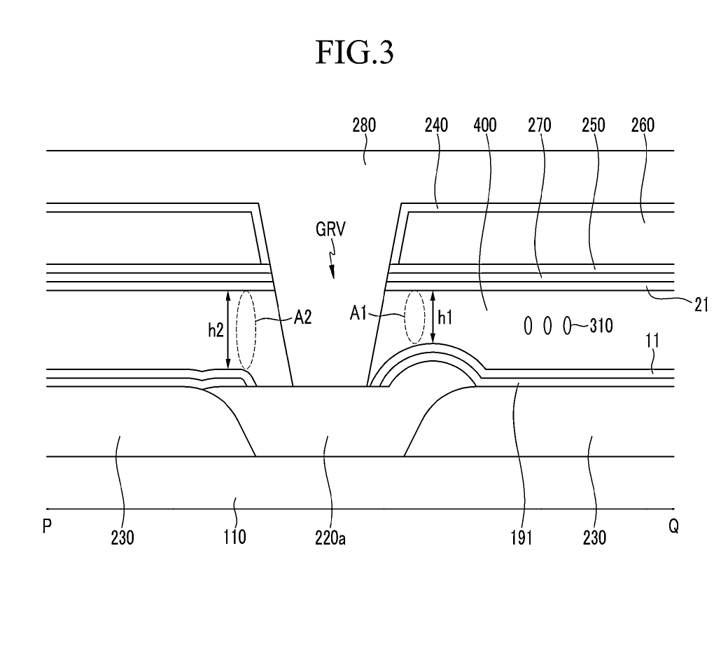

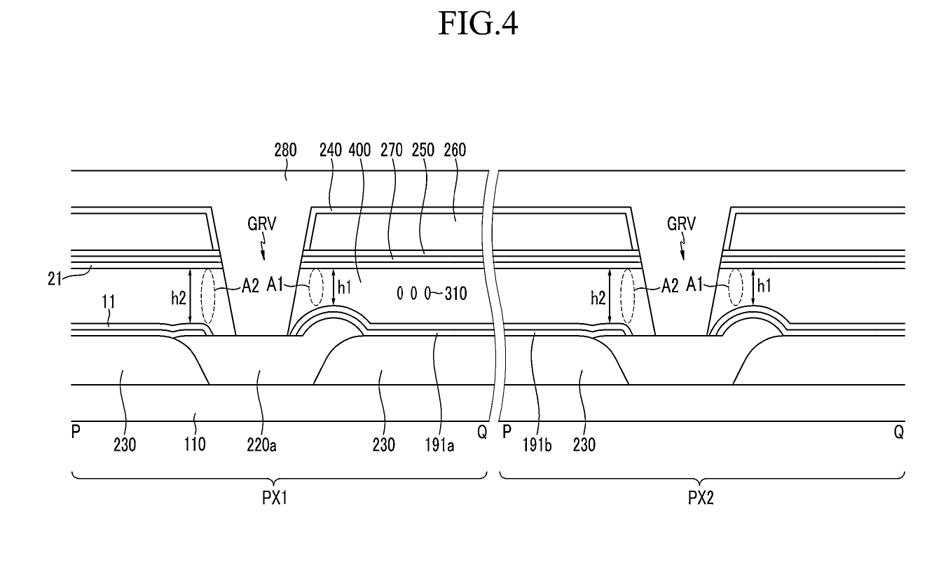

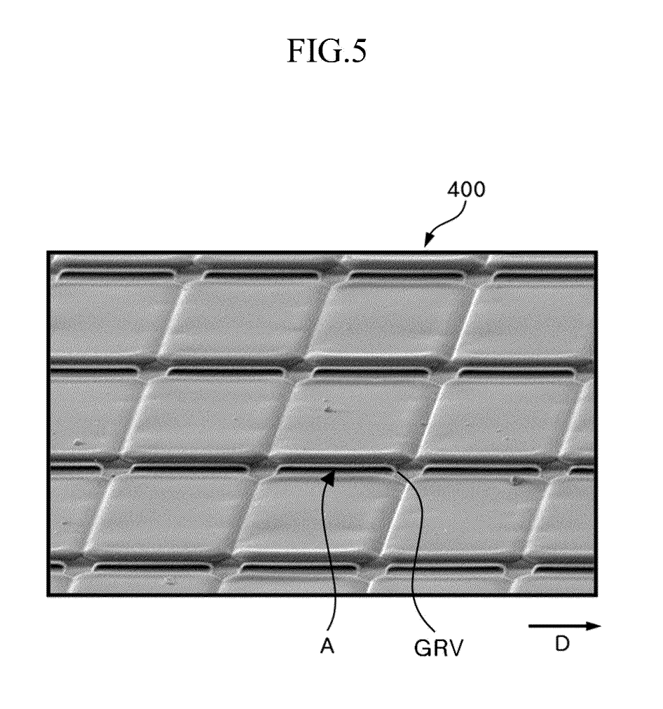

FIG. 1 is a top plan view of a liquid crystal display according to an exemplary embodiment of the present invention. FIG. 2 is a cross-sectional view taken along a line II-II of FIG. 1. FIG. 3 and FIG. 4 are cross-sectional views taken along a line III-III of FIG. 1. FIG. 5 is a perspective view of a microcavity layer according to the exemplary embodiment of FIG. 1 to FIG. 4.

Referring to FIG. 1 to FIG. 3, thin film transistors Qa, Qb, and Qc are formed on a substrate 110 made of transparent glass or plastic. An organic layer 230 is positioned on the thin film transistors Qa, Qb, and Qc, and a light blocking member 220 may be formed between neighboring organic layers 230. Here, the each organic layer 230 may be a color filter.

A pixel electrode 191 is positioned on the organic layer 230, and the pixel electrode 191 is electrically connected to one terminal of the thin film transistors Qa and Qb through contact holes 185a and 185b. FIG. 2 and FIG. 3 are the cross-sectional views taken along the lines II-II and III-III of FIG. 1, respectively, the constitutions between the substrate 110 and the organic layer 230 shown in FIG. 1 are omitted in FIG. 2 and FIG. 3, and only constitutions positioned on the organic layer 230 are shown. In reality, the partial constitution of the thin film transistors Qa, Qb, and Qc is included between the substrate 110 and the organic layer 230 in FIG. 2 and FIG. 3. The organic layer 230 may extend along a column direction of the pixel electrode 191. The organic layer 230 may be a color filter layer, and each of the color filters 230 may display one of primary colors such as three primary colors of red, green, and blue. However, this configuration is not limited to three primary colors such as red, green, and blue, and may display any other colors such as cyan, magenta, yellow, and white-based colors.

The neighboring organic layers 230 may be separated from each other in a horizontal direction D and in a vertical direction crossing (perpendicular or otherwise) the horizontal direction D in FIG. 1. FIG. 2 shows organic layers 230 that are separated from each other in the horizontal direction D, and FIG. 3 shows organic layers 230 that are separated from each other in the vertical direction. Referring to FIG. 2, longitudinal light blocking members 220b are positioned between the organic layers 230 that are spaced apart along the horizontal direction D. The longitudinal light blocking members 220b respectively overlap each edge of their neighboring organic layers 230, and a width by which the longitudinal light blocking members 220b overlap both edges of the organic layer 230 is substantially the same.

Referring to FIG. 3, a transverse light blocking member 220a is formed between the organic layers 230 that are spaced apart along the vertical direction with respect to FIG. 1.

Each transverse light blocking member 220a respectively overlaps its neighboring organic layers 230, and the width at which the transverse light blocking member 220a overlaps both edges of its neighboring organic layers 230 and a height at which the transverse light blocking member 220a extends above the overlapping portion is asymmetrical. That is, these widths and heights are different at different sides of the light blocking member 220a. For example, in the view of FIG. 3, when a portion overlapping the edge of the right organic layer 230 is referred to as the first portion of the transverse light blocking member 220a and a portion overlapping the edge of the left organic layer 230 is referred to as the second portion of the transverse light blocking member 220a, the height of the first portion is lower than the height of the second portion. That is, the second portion of member 220a extends to a height from the substrate 110 that is greater than that of the first portion.

FIG. 4 is a cross-sectional view taken along an extended line of the line III-III of FIG. 1. Referring to FIG. 4, one pixel PX is only shown in FIG. 1, however, in the liquid crystal display, the pixel PX are repeated in up/down/left/right directions thereby including a plurality of pixels. FIG. 4 shows two pixels PX1 and PX2 neighboring in a longitudinal direction with respect to FIG. 1 as a portion of a plurality of pixels.

In the present exemplary embodiment, in one pixel PX, two overlapping portions respectively positioned near the ends of a microcavity layer 400 are formed. The overlapping portions of the transverse light blocking member 220a formed in one pixel PX include the asymmetrical width and height. In detail, referring to FIG. 4 and FIG. 5, one microcavity layer 400 is positioned throughout the right portion of the first pixel PX1 the left portion of the second pixel PX2 neighboring to each other. This arrangement is due to the thin film transistor and pixel electrode structure, however, it is not limited and one pixel and one microcavity layer may be corresponded to each other as another exemplary embodiment. Hereafter, one microcavity layer 400 may be referred to as an unit microcavity layer.

A lower alignment layer 11 is formed on the pixel electrode 191, and may be a vertical alignment layer. The lower alignment layer 11, accommodating a liquid crystal alignment layer made of a material such as polyamic acid, polysiloxane, or polyimide, may include at least one among generally-used materials.

A microcavity layer 400 is formed on the lower alignment layer 11. That is, microcavity 400 is a cavity capable of holding liquids such as liquid crystal therein. The microcavity layer 400 is injected with a liquid crystal material including liquid crystal molecules 310, and the microcavity layer 400 has liquid crystal injection holes A1 and A2. The microcavity layer 400 may be formed to extend along a column direction of the pixel electrodes 191, in other words, in a longitudinal direction (that is, its major axis lies along the longitudinal direction).

In the present exemplary embodiment, the alignment material forming alignments layers 11 and 21 and a liquid crystal material including the liquid crystal molecules 310 may be injected into the microcavity layer 400 by using a capillary force. As described above, as the width of the transverse light blocking member 220a overlapping one edge of the organic layer 230 is increased, the height of the step is increased such that the thickness of the transverse light blocking member 220a becomes thick, a size of the liquid crystal injection holes A1 and A2 is decreased.

When, in one microcavity layer 400, the liquid crystal injection hole having a small size is referred to as the first liquid crystal injection hole and the liquid crystal injection hole having a larger size is referred to as the second liquid crystal injection hole, the height h1 of the first liquid crystal injection hole is lower than the height of the inner of the microcavity layer 400 or is lower than the height h2 of the second liquid crystal injection hole. That is, the cavity 400 has ends with holes A1 and A2 that have smaller cross-sectional areas than the remainder (i.e., the middle or central portion) of the cavity 400. The cavity 400 can be thought of as having depressions or narrow portions at its ends, which reduce its cross-section.

In general, the capillary force acts more strongly at the structurally narrow space, such that the capillary force acts more strongly at the first liquid crystal injection hole rather than the second liquid crystal injection hole in FIG. 4. In previous configurations, in one pixel PX, the sizes of the corresponding liquid crystal injection holes are the same or almost the same.

In the conventional art, in one microcavity layer 400, the sizes of the corresponding liquid crystal injection holes are almost the same.

In a process of manufacturing the liquid crystal display according to the present exemplary embodiment, the liquid crystal material is not only injected through the liquid crystal injection holes A1 and A2, but also the alignment material in which a solid and a solvent are mixed may be injected before the liquid crystal injection. That is, alignment material and liquid crystal material are successively injected into holes A1 and A2.

A drying process is performed after the injection of the alignment material. At this time, the solids remaining when the solvent of the aligning material is volatilized may be agglomerated inside the microcavity layer 400. In configurations in which A1 and A2 are of equal size, when drying simultaneously starts at the two injection holes of both sides and drying progresses to the center portion of the microcavity layer 400, the solids accumulate at the center portion of the microcavity layer 400, thereby generating a huddle defect. In this way, if the solids accumulate inside the microcavity layer 400, a display defect such as a light leakage or transmittance deterioration is generated. In other words, when the alignment material is dried, and when A1 and A2 are of roughly equal size, the solids of the alignment material can accumulate at the center of the pixel PX, producing undesired visual effects.

In the liquid crystal display according to the present exemplary embodiment, the capillary force acts more strongly at one side in one pixel PX such that the agglomeration of the solid is induced at the portion where the step of the light blocking member 220a is formed, thereby solving the above described problem. That is, when A1 and A2 are of unequal sizes, alignment material solids accumulate preferentially at one of the holes A1 or A2 (i.e., above one of the “bumps” or elevated portions of light blocking member 220a). In this manner, the solids accumulate above the light blocking member 220a, so that their accumulation is not visible to the viewer. In this manner, making A1 and A2 of unequal size acts to effectively move the accumulation of alignment material solids to hole A1 or A2. When these holes A1 and A2 are over the light blocking member 220a, the accumulated solids are not visible to the viewer, as the light blocking member 220a already blocks light. Undesired visual effects created by accumulations of alignment material solids are thus avoided.

Holes A1 and A2 are made to have differing cross sectional areas by making heights h1 and h2 different, as described above. The heights h1 and h2 can differ by any amount. However, in one embodiment, h1 and h2 may differ by about 0.8 μm. That is, h1 may be about 0.8 μm greater than h2. Alternatively, h1 and h2 can differ by a greater amount, such as about 1.3 μm or more.

Liquid crystal 310 is then injected into layer 400 through the same holes A1 and A2.

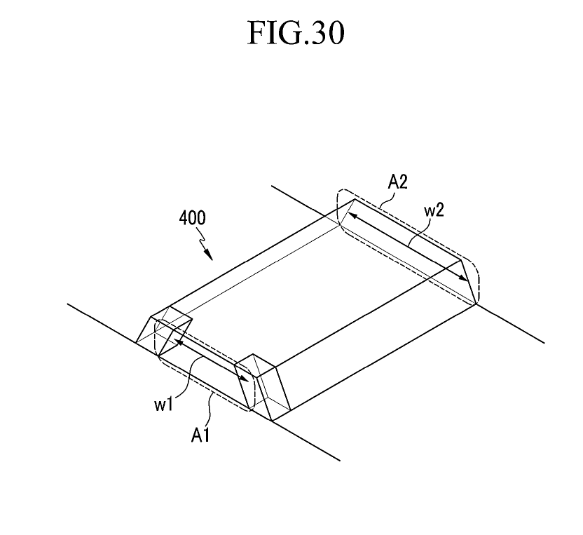

In the present exemplary embodiment, the heights of the liquid crystal injection holes positioned at both ends in the microcavity layer 400 are different to have the capillary force strongly acting at one side in one microcavity layer 400. However, this structure is only one in an exemplary embodiment of the present invention, widths of the liquid crystal injection holes may be different to have the capillary force strongly acting at one side in one microcavity layer 400. In other words, In an exemplary embodiment of the present invention, a cross-sectional area of the microcavity layer 400 in which the first liquid crystal injection hole A1 is positioned may be smaller than the is cross-sectional area of the microcavity layer 400 in which the first liquid crystal injection hole A1 is positioned. This will be described later with reference to FIG. 30.

In the exemplary embodiment described in FIG. 4, the liquid crystal injection holes having the different heights are formed in each edge of the microcavity layers 400 facing to each other with respect to the groove GRV in one pixel PX1 and PX2, however, the different heights of the liquid crystal injection holes facing to each other may be equal to each other as another exemplary embodiment. However, in this case, the different heights of the liquid crystal injection holes of the edges of both sides must be different in one microcavity layer 400.

In the present exemplary embodiment, one the liquid crystal injection hole is respectively formed at both edges of one microcavity layers 400, however one the liquid crystal injection hole may be formed at one edge of one microcavity layers 400 in another exemplary embodiment. In this case, it is preferable that the height of the liquid crystal injection hole formed at one edge is lower than the height of the other edge of the microcavity layer 400.

The upper alignment layer 21 is positioned on the microcavity layer 400, and a common electrode 270 and an overcoat 250 are formed on the upper alignment layer 21. In operation, the common electrode 270 receives a common voltage and the pixel electrode 191 receives a data voltage, to collectively generate an electric field. This electric field determines an inclination direction of the liquid crystal molecules 310 positioned in the minute space layer 400 between the two electrodes. The common electrode 270 and the pixel electrode 191 form a capacitor (hereafter referred to as “a liquid crystal capacitor”) to maintain the applied voltage after the thin film transistor is turned off.

The overcoat 250 may be formed of silicon nitride (SiNx) or silicon oxide (SiO2). A supporting member 260 is positioned on the overcoat 250. The supporting member 260 may include silicon oxycarbide (SiOC), a photoresist, or an organic material. When the supporting member 260 includes silicon oxycarbide (SiOC), a chemical vapor deposition method may be used, and when it includes photoresist, a coating method may be applied. Among layers that may be formed through chemical vapor deposition, silicon oxycarbide (SiOC) has relatively high transmittance and low layer stress, thereby being relatively stable. Accordingly, in the present exemplary embodiment, the supporting member 260 is formed of silicon oxycarbide (SiOC) such that light is well transmitted and the layer is stable.

A groove GRV may be formed to pass through the microcavity layer 400, the upper alignment layer 21, the common electrode 270, the overcoat 250, and the supporting member 260 is formed on the transverse light blocking member 220a. The transverse light blocking member 220a may simultaneously overlap both an end of the supporting member 260 and an edge of the neighboring organic layers 230.

Next, the microcavity layer 400 will be described with reference to FIG. 2 to FIG. 5.

Referring to FIG. 2 to FIG. 5, the microcavity layer 400 is divided by a plurality of grooves GRV positioned over gate lines 121a, and a plurality of microcavity layers 400 are formed along direction D, along which the gate lines 121a extend. Here, the pixel region may correspond to the region displaying the images.

The microcavity layers 400 may each respectively correspond to a pixel area, and multiple groups of the plurality of microcavity layers 400 may be formed in the column direction. As shown, the grooves GRV formed between the microcavity layers 400 may be positioned along the direction D that the gate line 121a extends, and the liquid crystal injection holes A1 and A2 of the microcavity layer 400 form a region corresponding to a boundary of the groove GRV and the microcavity layer 400. The liquid crystal injection holes A1 and A2 are formed according to a direction that the groove GRV extends. Also, an opening part OPN formed between neighboring microcavity layers 400 in the direction D that the gate line 121a extends may be covered by the supporting member 260 as shown in FIG. 2.

The liquid crystal injection holes A1 and A2 included in the microcavity layer 400 may have a greater height between the supporting member 260 and the pixel electrode 191, but may have a lesser height between the upper alignment layer 21 and the lower alignment layer 11. In the present exemplary embodiment, the grooves GRV are formed along the direction D that the gate line 121a extends, however as another exemplary embodiment, a plurality of grooves GRV may be formed along a direction that a data line 171 extends, and multiple groups of the plurality of microcavity layers 400 may be formed in a row direction. The liquid crystal injection holes A1 and A2 may be formed according to an extension direction of the groove GRV. That is, the holes A1 and A2 can be formed along the respective grooves GRV.

A passivation layer 240 is positioned on the supporting member 260. The passivation layer 240 may include silicon nitride (SiNx) or silicon oxide (SiO2). A capping layer 280 is positioned on the passivation layer 240. The capping layer 280 contacts the upper surface and the side surface of the supporting member 260, and the capping layer 280 covers the liquid crystal injection holes A1 and A2 of the microcavity layer 400 exposed by the groove GRV. The capping layer 280 may include a thermal hardening resin, silicon oxycarbide (SiOC), or graphene. When the capping layer 280 includes graphene, the graphene has transmission resistance against a gas including helium, thereby acting as a capping layer for capping the is liquid crystal injection hole A. The capping layer 280 including graphene has a structure, which carbons combine each other, such that the liquid crystal material is not contaminated even if it contacts the capping layer 280. Also, the graphene protects the liquid crystal material from oxygen or moisture from the outside.

In the present exemplary embodiment, the liquid crystal material is injected through the liquid crystal injection hole A of the minute space layer 400, thereby forming a liquid crystal display without the additional formation of an upper substrate. That is, the microcavities 400 hold a liquid crystal layer on the same substrate 110 as the pixel electrode 191 and common electrode 270, thus preventing the need for a second substrate. This has significant advantages, including allowing for a thinner display than conventional displays that use two substrates, as well as making for cheaper and more easily manufacturable displays.

An overcoat (not shown) made of an organic layer or an inorganic layer may be positioned on the capping layer 280. The capping layer 280 protects the liquid crystal molecules 310 injected into the microcavity layer 400 from an external impact that may flatten them.

Next, again referring to FIG. 1 to FIG. 4, the liquid crystal display according to the present exemplary embodiment will be described. Referring to FIG. 1 to FIG. 4, a plurality of gate conductors including a plurality of gate lines 121a, a plurality of step-down gate lines 121b, and a plurality of storage electrode lines 131 are formed on a substrate 110 made of transparent glass or plastic. The gate lines 121a and the step-down gate lines 121b extend mainly in a transverse direction and transmit gate signals. The gate line 121a includes a first gate electrode 124a and a second gate electrode 124b protruding upward and downward respectively in the view of FIG. 1, and the step-down gate line 121b includes a third gate electrode 124c protruding upward in the view of FIG. 1. The first gate electrode 124a and the second gate electrode 124b are connected to each other to form a single protrusion.

The storage electrode lines 131 are mainly extended in the transverse direction (i.e. along direction D in FIG. 1), and transfer a predetermined voltage such as a common voltage. Each storage electrode line 131 includes a storage electrode 129 protruding up and down from the storage electrode line 131 in the view of FIG. 1, a pair of longitudinal portions 134 extending substantially perpendicular to the gate lines 121a and 121b and downward, and a transverse portion 127 connecting ends of the pair of longitudinal portions 134. The transverse portion 127 includes a capacitive electrode 137 extending downward. A gate insulating layer 140 is formed on the gate conductors 121a, 121b, and 131.

A plurality of semiconductor stripes (partially shown) that may be made of amorphous silicon or crystallized silicon are formed on the gate insulating layer 140. The semiconductor stripes mainly extend in the longitudinal direction, and include first and second semiconductors 154a and 154b protruding toward the first and second gate electrodes 124a and 124b and connected to each other, and a third semiconductor 154c disposed on the third gate electrode 124c.

A plurality of pairs of ohmic contacts (not shown) are formed on the semiconductors 154a, 154b, and 154c. The ohmic contacts may be made of silicide or of n+ hydrogenated amorphous silicon doped with an n-type impurity at a high concentration.

A data conductor including a plurality of data lines 171, a plurality of first drain electrodes 175a, a plurality of second drain electrodes 175b, and a plurality of third drain electrodes 175c is formed on the ohmic contacts. The data lines 171 transmit data signals and extend in a longitudinal direction, thereby intersecting, though insulated from, the gate line 121a and the step-down gate line 121b. Each data line 171 includes a first source electrode 173a and a second source electrode 173b extending toward the first gate electrode 124a and the second gate electrode 124b respectively, and connected to each other.

The first drain electrode 175a, the second drain electrode 175b, and a third drain electrode 175c each include one end having a wide area and the other end having a bar type shape. Bar ends of the first drain electrode 175a and the second drain electrode 175b are partially enclosed by the first source electrode 173a and the second source electrode 173b. The wide end of the first drain electrode 175a also has a portion extending to semiconductor 154c, thereby forming a third drain electrode 175c which is curved to have a “U” shape. A wide end 177c of the third source electrode 173c overlaps the capacitive electrode 137, thereby forming a step-down capacitor Cstd, and the bar end is partially enclosed by the third drain electrode 175c.

The first gate electrode 124a, the first source electrode 173a, and the first drain electrode 175a form a first thin film transistor Qa along with the first semiconductor 154a; the second gate electrode 124b, the second source electrode 173b, and the second drain electrode 175b form a second thin film transistor Qb along with the second semiconductor 154b, and the third gate electrode 124c, the third source electrode 173c, and the third drain electrode 175c form a third thin film transistor Qc along with the third semiconductor 154c. The semiconductor stripes including the first semiconductor 154a, the second semiconductor 154b, and the third semiconductor 154c except for the channel region between the source electrodes 173a, 173b, and 173c, and the drain electrodes 175a, 175b, and 175c have substantially the same plane shape as the data conductors 171a, 171b, 173a, 173b, 173c, 175a, 175b, and 175c and the underlying ohmic contacts (i.e., the same shape in the plan view of FIG. 1). The first semiconductor 154a includes a portion that is not covered by the first source electrode 173a and the first drain electrode 175a to be exposed between the first source electrode 173a and the first drain electrode 175a, the second semiconductor 154b includes a portion that is not covered by the second source electrode 173b and the second drain electrode 175b to be exposed between the second source electrode 173b and the second drain electrode 175b, and the third semiconductor 154c includes a portion that is not covered by the third source electrode 173c and the third drain electrode 175c to be exposed between the third source electrode 173c and the third drain electrode 175c.

A lower passivation layer (not shown) made of an inorganic insulator such as silicon nitride or silicon oxide is formed on the data conductors 171a, 171b, 173a, 173b, 173c, 175a, 175b, and 175c and the exposed first, second, and third semiconductors 154a, 154b, and 154c. The organic layer 230 may be positioned on the lower passivation layer. The organic layer 230 is present across most of the display area except for positions where the first thin film transistor Qa, the second thin film transistor Qb, and the third thin film transistor Qc are disposed. However, it may extend in the longitudinal direction along the space between adjacent data lines 171. In the present exemplary embodiment, the organic layer 230 may be a color filter, and the color filter 230 may be formed under the pixel electrode 191, however it may alternatively be formed on the common electrode 270.

The light blocking member 220 is positioned on a region where the organic layer 230 is not present, and on a portion of the organic layer 230. That is, light blocking members 220 are positioned between, and slightly overlapping, neighboring organic layers 230. The light blocking member 220 includes transverse light blocking member 220a extending along the gate line 121a and the step-down line 121b, and covering the region at which the first thin film transistor Qa, the second thin film transistor Qb, and the third thin film transistor Qc are disposed, as well as longitudinal light blocking member 220b that extends along the data lines 171. The light blocking member 220 is referred to as a black matrix, and prevents light leakage. The lower passivation layer and the light blocking member 220 have a plurality of contact holes 185a and 185b exposing the first drain electrode 175a and the second drain electrode 175b, respectively.

Also, a pixel electrode 191 including a first sub-pixel electrode 191a and a second sub-pixel electrode 191b is formed on the organic layer 230 and the light blocking member 220. The first sub-pixel electrode 191a and the second sub-pixel electrode 191b are positioned on opposite sides of the gate line 121a and the step-down gate line 121b, and are disposed up and down such that they are adjacent to each other in the column direction. The height of the second sub-pixel electrode 191b is greater than the height of the first sub-pixel electrode 191a, and may be in a range of about 1 to 3 times that of the first sub-pixel electrode 191a. Each overall shape of the first sub-pixel electrode 191a and the second sub-pixel electrode 191b is a quadrangle, and the first sub-pixel electrode 191a and the second sub-pixel electrode 191b respectively include a cross stem including transverse stems 193a and 193b and longitudinal stems 192a and 192b crossing the transverse stems 193a and 193b. Also, the first sub-pixel electrode 191a includes a plurality of minute branches 194a and a lower protrusion 197a and, the second sub-pixel electrode 191b includes a plurality of minute branches 194b and an upper protrusion 197b. The pixel electrode 191 is divided into four sub-regions by the transverse sterns 193a and 193b and the longitudinal stems 192a and 192b. The minute branches 194a and 194b obliquely extend from the transverse stems 193a and 193b and the longitudinal stems 192a and 192b, and the extending direction thereof forms an angle of about 45 degrees or 135 degrees with the gate lines 121a and 121b or the transverse stems 193a and 193b. Also, the minute branches 194a and 194b of two neighboring sub-regions may be crossed. In the present exemplary embodiment, the first sub-pixel electrode 191a further includes an outer stem enclosing the outer portion, and the second sub-pixel electrode 191b further includes a transverse portion disposed on the upper and lower portions and right and left longitudinal portions 198 disposed on the right and left sides of the second sub-pixel electrode 191b. The right and left longitudinal portions 198 may prevent capacitive coupling between the data line 171 and the first sub-pixel electrode 191a. The lower alignment layer 11, the microcavity layer 400, the upper alignment layer 21, the common electrode 270, the overcoat 250, and the capping layer 280 are formed on the pixel electrode 191, and the description of these constituent elements is not repeated here.

The description related to the liquid crystal display described above is one example of the visibility structure to improve the later visibility, the structure of the thin film transistor and the design of the pixel electrode is not limited to the structure described in the present exemplary embodiment, and variations may be applied to the description according to an exemplary embodiment of the present invention.

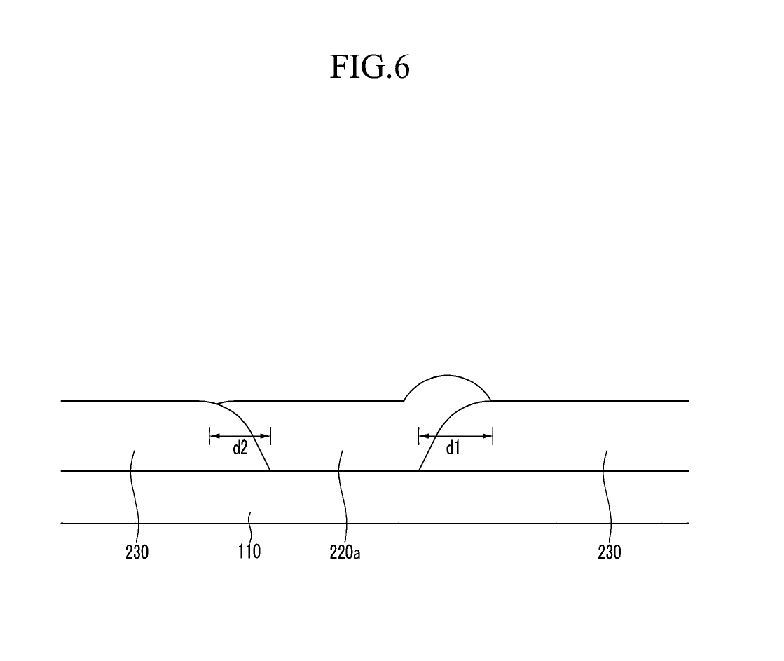

FIG. 6 to FIG. 12 are cross-sectional views of a manufacturing method of a liquid crystal display according to another exemplary embodiment of the present invention. FIG. 6 to FIG. 12 sequentially show cross-sectional views of a liquid crystal display taken along the line III-III of FIG. 1. Referring to FIG. 6, thin film transistors Qa, Qb, and Qc (shown in FIG. 1) are formed on a substrate 110 made of transparent glass or plastic. An organic layer 230 corresponding to a pixel area is formed between and above the thin film transistors Qa, Qb, and Qc, and a light blocking member 220 is formed between the neighboring organic layers 230 and over the thin film transistors Qa, Qb, and Qc. The light blocking member 220a overlaps the edge of the neighboring organic layer 230.

In the present exemplary embodiment, the width d1 of the light blocking member 220a overlapping one edge of the organic layer 230 may be formed to be larger than the width d2 of the light blocking member 220a overlapping the other edge of the organic layer 230. As the amount of overlap is increased, the step of the light blocking member 220a is increased.

In FIG. 6, the light blocking member 220a simultaneously overlaps both of its neighboring organic layers 230, and as shown in FIG. 4, the structure of FIG. 6 may be repeated along the vertical direction. Accordingly, the widths of the light blocking member 220a overlapping both edges of the organic layer 230 may be different in both ends of the microcavity layer 400. Here, the organic layer 230 may be a color filter.

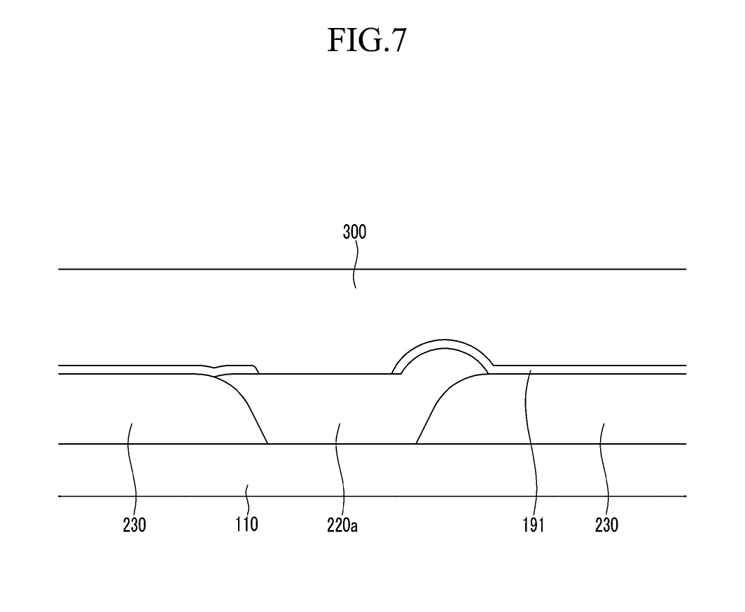

Referring to FIG. 7, a pixel electrode material is formed on the organic layer 230, and is patterned for the pixel electrode 191 to be positioned at a portion corresponding to the pixel region. At this time, the pixel electrode 191 is electrically connected to one terminal of the thin film transistors Qa and Qb through contact holes 185a and 185b (shown in FIG. 1). A sacrificial layer 300 including silicon oxycarbide (SiOC) or a photoresist is formed on the pixel electrode 191. The sacrificial layer 300 may be formed of an organic material as well as silicon oxycarbide (SiOC) or photoresist.

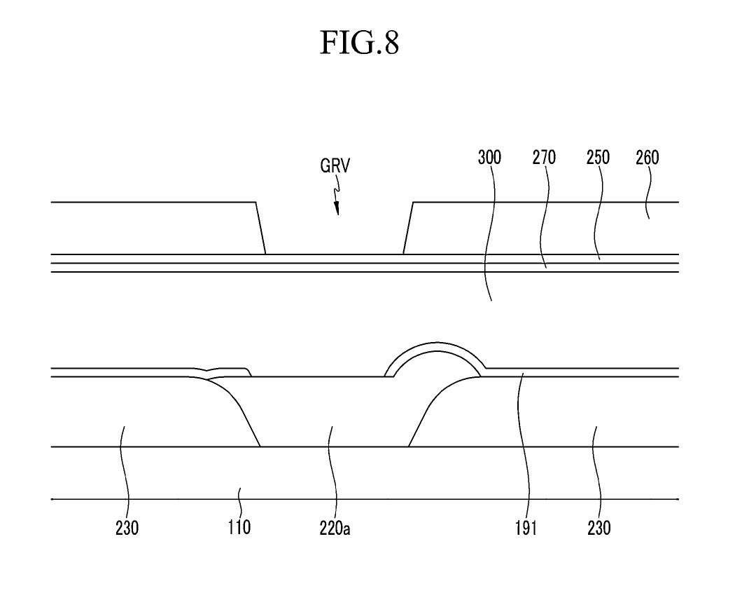

Referring to FIG. 8, a common electrode 270, an overcoat 250, and a supporting member 260 are sequentially formed on the sacrificial layer 300. The common electrode 270 may be made of a transparent conductor such as ITO or IZO, and the overcoat 250 may be made of silicon nitride (SiNx) or silicon oxide (SiO2). The supporting member 260 according to the present exemplary embodiment may be made of a different material from the sacrificial layer 300. By patterning the supporting member 260, a groove GRV exposing the overcoat 250 of the portion corresponding to the light blocking member 220a is formed.

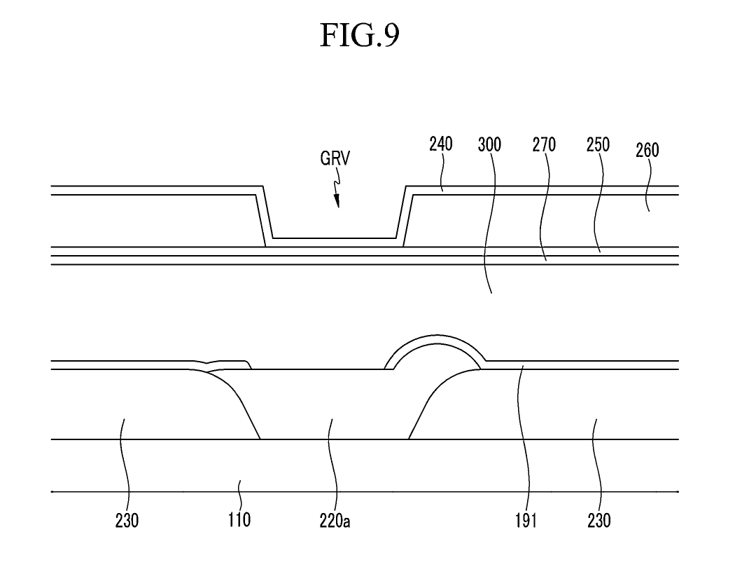

Referring to FIG. 9, a passivation layer 240 covering the exposed overcoat 250 and the supporting member 260 is formed. The passivation layer 240 may be made of silicon nitride (SiNx) or silicon oxide (SiO2).

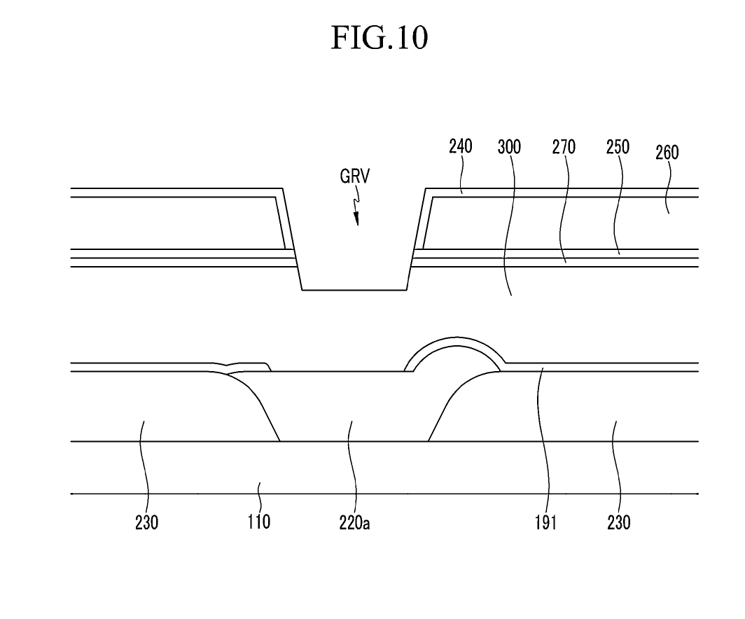

Referring to FIG. 10, the passivation layer 240 formed with the groove GRV, the overcoat 250, and the common electrode 270 corresponding to the groove GRV is sequentially patterned to expose the sacrificial layer 300. At this time, a portion of the sacrificial layer 300 corresponding to the groove GRV may be removed.

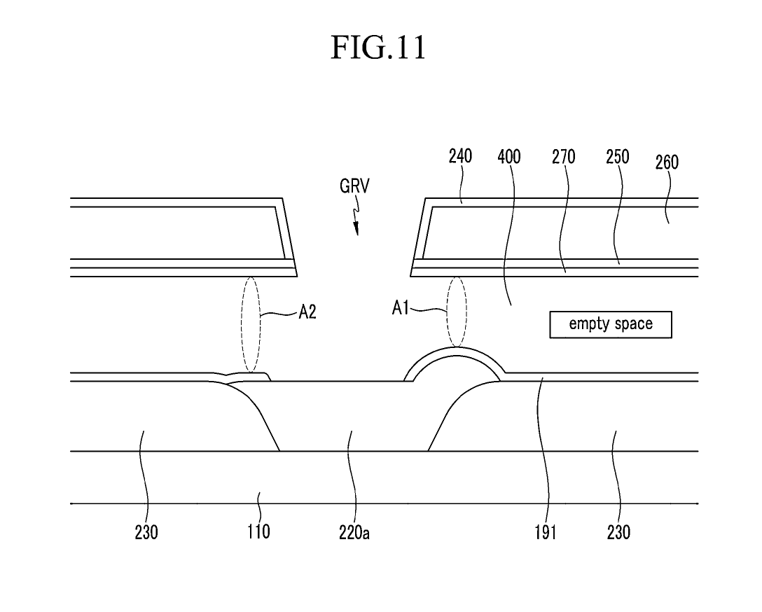

Referring to FIG. 11, the sacrificial layer 300 is removed through the groove GRV by an O2 asking process or a wet etching method. This forms a microcavity layer 400 having the first and the second liquid crystal injection holes A1 and A2. The microcavity layer 400 is an empty space where the sacrificial layer 300 is removed. The liquid crystal injection holes A1 and A2 may be formed in a direction substantially parallel to the signal line connected to one terminal of the thin film transistor.

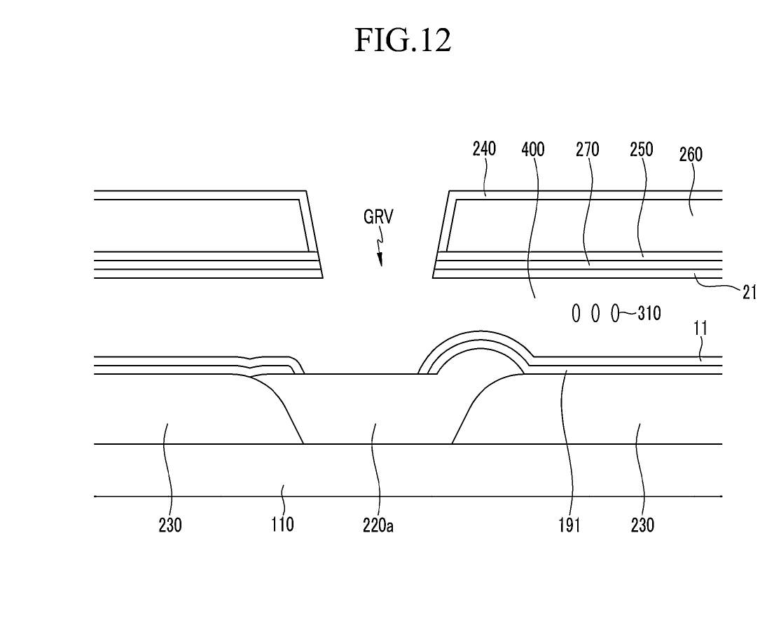

Referring to FIG. 12, an alignment material is injected through the groove GRV and the liquid crystal injection holes A1 and A2 to form alignment layers 11 and 21 on the pixel electrode 191 and the common electrode 270. A baking process is performed after injecting the alignment material through the liquid crystal injection holes A1 and A2. The alignment material includes both solids and a solvent. Thus, during this step, the alignment layer is formed while the solvent of the alignment material is volatilized, and the remaining solids accumulate over the larger of the “bumps” in light blocking member 220a, i.e. over the smaller of the two holes A1 and A2.

Next, the liquid crystal molecules 310 are injected into the microcavity layer 400 through the groove GRV and the liquid crystal injection holes A1 and A2, using an inkjet method. Here, the alignment layers 11 and 21 somewhat reduce the size of the liquid crystal injection holes A1 and A2.

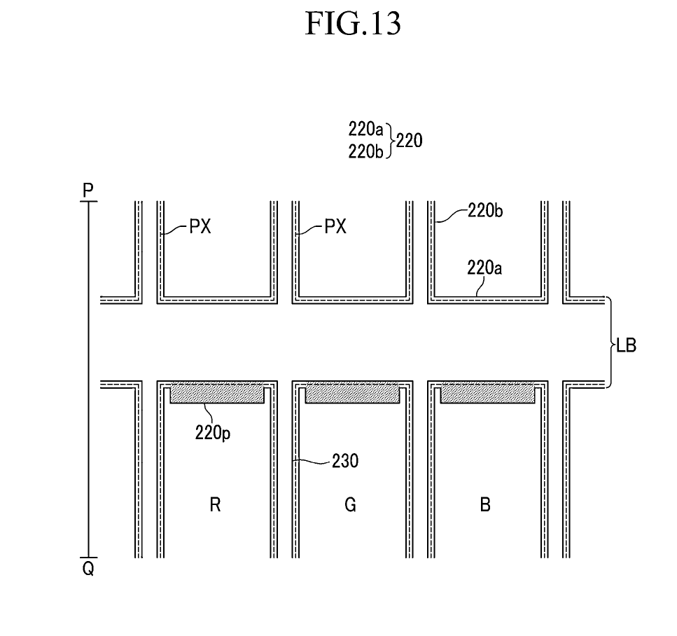

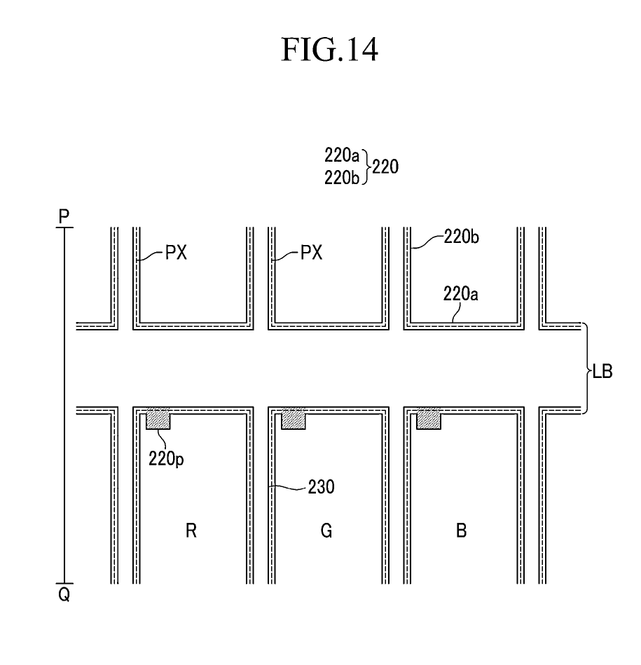

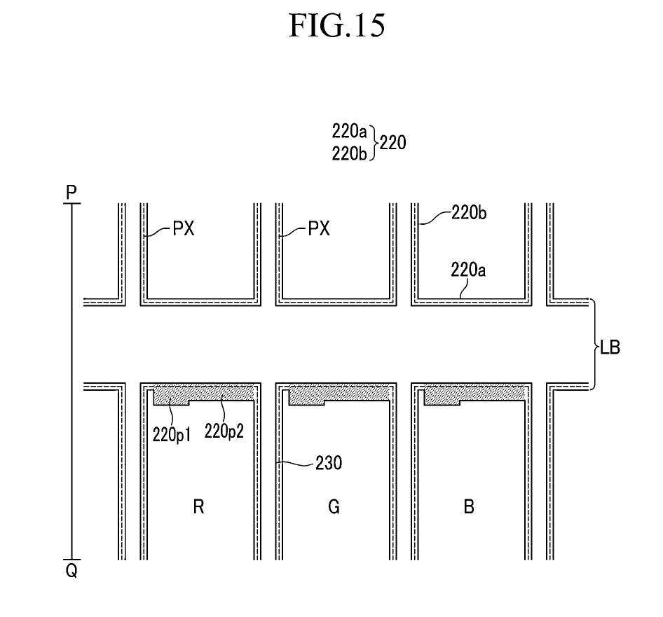

Next, a capping layer 280 (shown in FIG. 3) covering the upper surface and the side surface of the supporting member 260 is formed. At this time, the capping 280 covers the liquid crystal injection holes A1 and A2 of the microcavity layer 400 exposed through the groove GRV. FIG. 13 is a top plan view viewing a liquid crystal display according to an exemplary embodiment of the present invention from a position P to a position Q of FIG. 3 for explanation. FIG. 14 and FIG. 15 are top plan views to schematically explain a liquid crystal display according to an exemplary embodiment of the present invention.

Referring to FIG. 13, a light blocking member 220 is formed at a light blocking region LB corresponding to the separation space between neighboring sections of organic layer 230. As described above, the areas of the overlapping region the transverse light blocking member 220a and the organic layer 230 at the upper end and the lower end via the light blocking region LB are asymmetry. As shown FIG. 13, the first portion that the transverse light blocking member 220a further largely overlaps the organic layer 230 in the lower end of the light blocking region LB compared with the upper end is formed. The first portion 220p of the transverse light blocking member 220a substantially corresponds to the entire transverse edge of the pixel PX or the entire one edge of the unit micorcavity layer 400.

However, if the first portion 200p of the transverse light blocking member 220a is formed to overlap the edge of the organic layer 230 at the entire region of the transverse edge of the pixel PX, the solid remaining while the alignment material is dried may close the liquid crystal injection hole. To prevent this problem, a preferable exemplary embodiment will be described with reference to FIG. 14. Referring to FIG. 14, the transverse light blocking member 220a in the present exemplary embodiment includes a protrusion light blocking member 220p protruded toward and overlapping the organic layer 230. In the protrusion light blocking member 220p, the protrusion is formed by the overlapping of member 220p with the organic layer 230 such that the solid remaining after the alignment material is dried is concentrated over the protrusion light blocking member 220p. Accordingly, a possibility that the liquid crystal injection hole may be partially blocked is reduced. In other words, in the embodiment of FIG. 14, the “bump” formed in the light blocking member 220a extends across only a portion of the opening A1 or A2. In this manner, solids from the alignment material only accumulate over the bump, and not over the entire opening A1/A2. This reduces the possibility that the accumulated solids will block the opening A1/A2. Also, each light blocking member 220p can take up any amount of the width of the opening A1, A2 under which it is located. As one example, the light blocking member 220p can take up less than or equal to about 80% of the width of its opening A1/A2. Any percentage is contemplated, so long as the member 220p does not occlude its opening A1/A2 to the point where liquid cannot be readily injected into cavity 400, and so long as solids from the alignment material accumulate over member 220p.

A variation on the exemplary embodiment of FIG. 14 will be described with reference to FIG. 15.

Referring to FIG. 15, the transverse light blocking member 220a includes a first protrusion light blocking member 220p1 and a second protrusion light blocking member 220p2 overlapping the organic layer 230 along the transverse edge of the pixel PX. At this time, the overlapping area of the second protrusion light blocking member 220p2 and the organic layer 230 is smaller than the overlapping area of the first protrusion light blocking member 220p1 overlapping the organic layer 230. Accordingly, a thickness of the first protrusion light blocking member 220p1 is larger than a thickness of the second protrusion light blocking member 220p2. The described exemplary embodiment is not limited thereto, and the protrusion light blocking member 220p may take on various shapes besides that shown. The light blocking members 220p1, 220p2 can have any suitable heights, so long as liquid can still be injected into openings A1/A2 and alignment material still accumulates over one or more of the members 220p1, 220p2. As one example, member 220p1 may be about 0.5 μm greater in height than member 220p2, or vice versa. As another example,

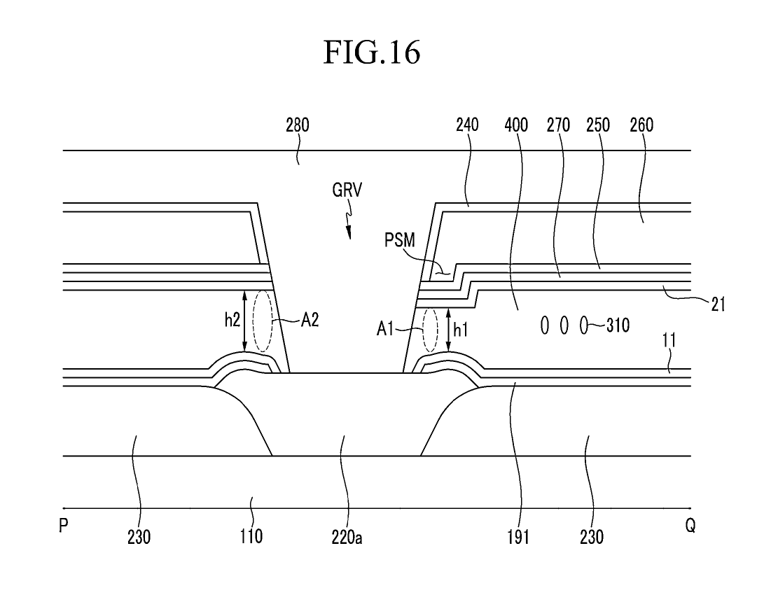

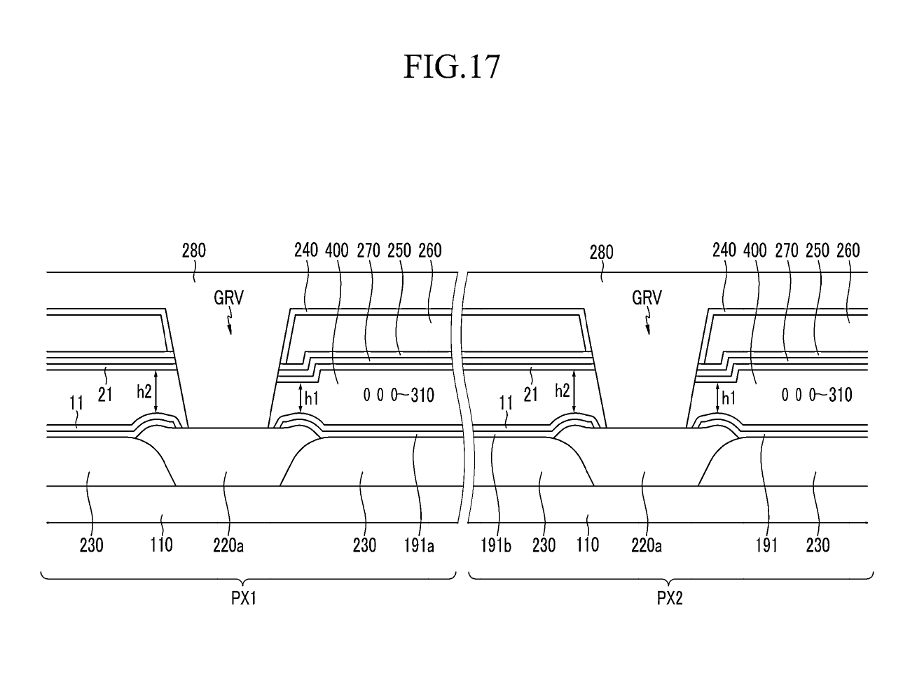

FIG. 16 and FIG. 17 are a cross-sectional view taken along the line III-III of FIG. 1 to explain a liquid crystal display according to an exemplary embodiment of the present invention. The exemplary embodiment shown in FIG. 16 and FIG. 17 has a structural difference from the exemplary embodiment shown in FIG. 1 to FIG. 5. However, similarities between the two are largely omitted, and differences from the exemplary embodiment of FIG. 1 to FIG. 5 are mainly described.

Referring to FIGS. 16 and 17, the light blocking member 220a formed on the organic layer 230 overlaps both edges of the organic layer 230 to the same degree. That is, the amounts of overlap at each side of the light blocking member 220a have the same width. However, the microcavity layer 400 between the lower alignment layer 11 and the upper alignment layer 21 is asymmetrical with respect to the light blocking member 220a. In one pixel PX, one end of the microcavity layer 400 has an upper surface that is depressed downward. In detail, the heights h1 and h2 of the liquid crystal injection hole where the groove GRV and the microcavity layer 400 meet are different from each other.

A protrusion supporting member PSM protruding downward is formed in the end of the supporting member 260 at the position corresponding to one end of the microcavity layer 400 having the depressed upper surface. When the portion of the supporting member 260 formed with the protrusion supporting member PSM is referred to as a first supporting part and a portion of the supporting member 260 without the protrusion supporting member PSM is referred to as a second supporting part, a thickness of the first supporting part is thicker than a thickness of the second supporting part.

FIG. 16 focuses on the light blocking member 220a positioned between the neighboring pixels PX. However, as shown in FIG. 17, the structure of FIG. 16 may be repeated along the vertical direction with reference to FIG. 1.

In the present exemplary embodiment, the shape of both ends of the microcavity layer 400 corresponding to the liquid crystal injection holes A1 and A2 is asymmetrical in one microcavity layer 400, such that the capillary force more strongly acts at the liquid crystal injection hole A2. Accordingly, the solid is not agglomerated inside one microcavity layer 400 at the interior of the pixel PX, but is instead agglomerated near where the light blocking member 220a is formed, thereby preventing light leakage.

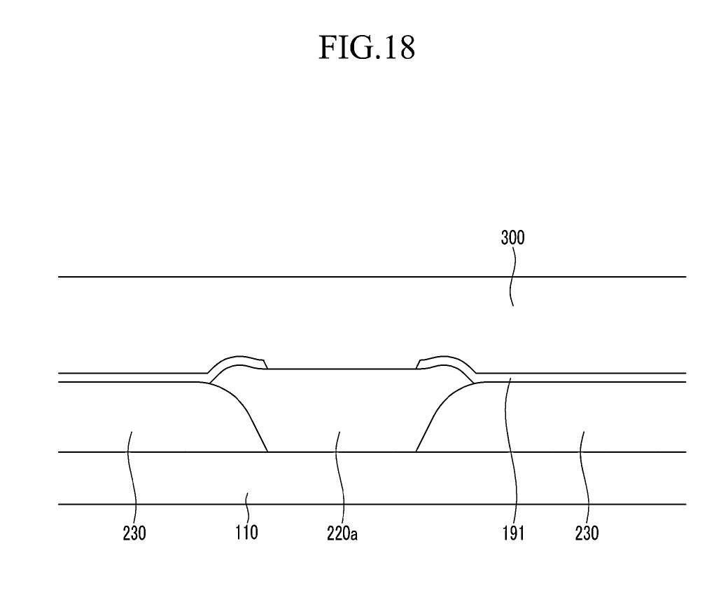

Next, an exemplary method of manufacturing the above liquid crystal display will be described with reference to FIG. 18 to FIG. 25. FIG. 18 to FIG. 25 sequentially show cross-sectional views taken along the line III-III of FIG. 1. FIG. 18 to FIG. 25 are cross-sectional views for a method of manufacturing a liquid crystal display according to another exemplary embodiment of the present invention. Referring to FIG. 18, thin film transistors Qa, Qb, and Qc (shown in FIG. 1) are formed on a substrate 110 made of transparent glass or plastic. An organic layer 230 corresponding to a pixel area is formed on the thin film transistors Qa, Qb, and Qc, and a light blocking member 220a is formed between the neighboring organic layers 230. The light blocking member 220a overlaps the edges of its neighboring organic layers 230. In the present exemplary embodiment, the widths of the light blocking member 220a overlapping both edges of the organic layer 230 are substantially the same. That is, the amount of overlap between the organic layers 230 and each side of the light blocking member 220a are substantially the same. Here, the organic layer 230 may be a color filter. A pixel electrode 191 is formed on the organic layer 230 and the light blocking member 220a.

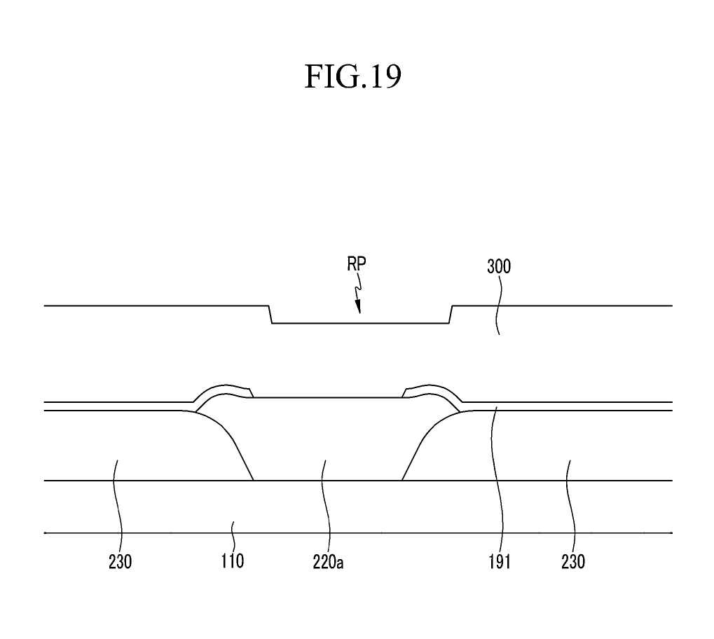

Referring to FIG. 19, a sacrificial layer 300 is formed on the pixel electrode 191. The sacrificial layer 300 may be formed of an organic material. The sacrificial layer is patterned by using a half tone mask or a slit mask. At this time, a depression RP is formed at the portion corresponding to the light blocking member 220a. The depression RP is asymmetrical with respect to the light blocking member 220a.

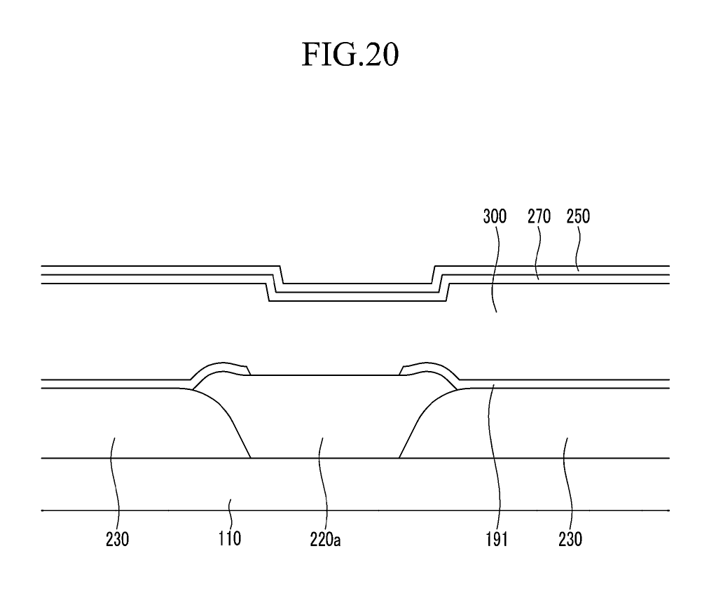

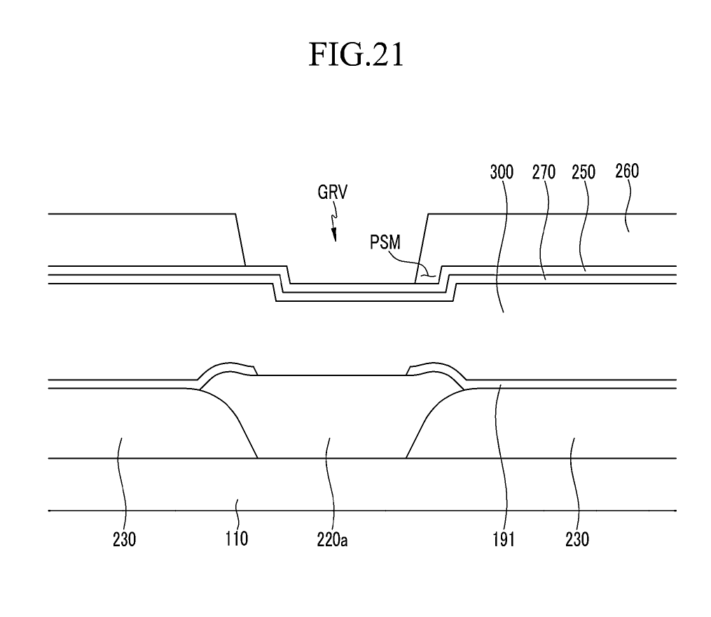

Referring to FIG. 20, a common electrode 270 and an overcoat 250 are sequentially formed on the sacrificial layer 300. The common electrode 270 may be made of a transparent conductor such as ITO or IZO, and the overcoat 250 may be made of silicon nitride (SiNx) or silicon oxide (SiO2). Referring to FIG. 21, a supporting member 260 is formed on the overcoat 250 and is patterned to form a groove GRV exposing the portion of the overcoat 250 corresponding to the light blocking member 220a. The groove GRV may be symmetrically placed with respect to the light blocking member 220a, so that the depression RP (that is asymmetrically formed with respect to the light blocking member 220a) and the groove GRV are offset. Accordingly, a protrusion supporting portion PSM protruded downward from the end of the supporting member 260 is formed.

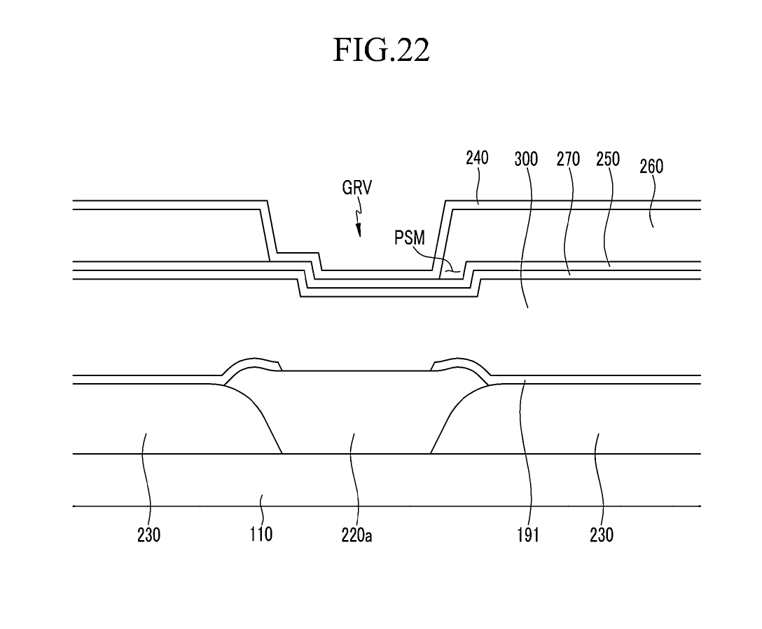

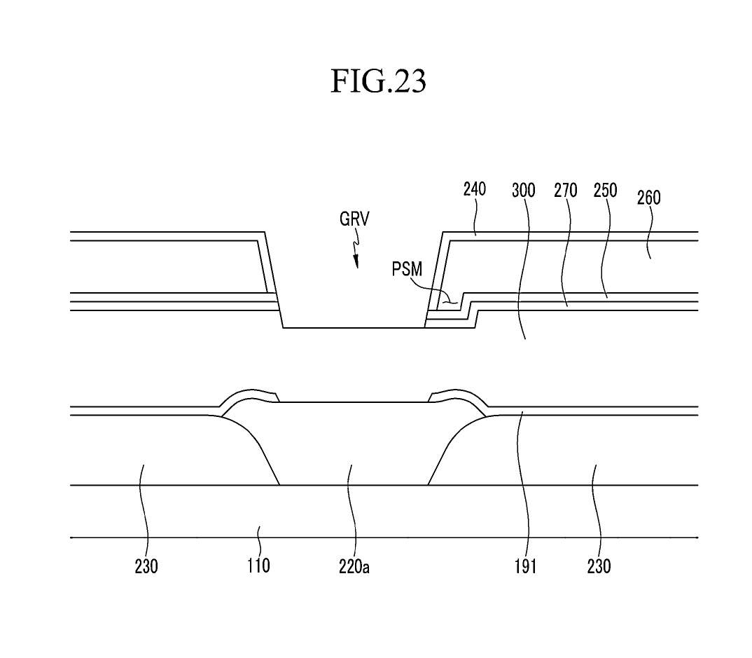

Referring to FIG. 22, a passivation layer 240 covering the exposed overcoat 250 and the supporting member 260 is formed. The passivation layer 240 may be made of silicon nitride (SiNx) or silicon oxide (SiO2). Referring to FIG. 23, the passivation layer 240 formed with the groove GRV, the overcoat 250, and the common electrode 270 are sequentially patterned to expose the sacrificial layer 300. At this time, a portion of the sacrificial layer 300 corresponding to the groove GRV may be removed. At this time, the protrusion supporting portion PSM is protected by passivation layer 240 so that its shape is maintained. This keeps the shape of the supporting member 260 asymmetrical with respect to the light blocking member 220a.

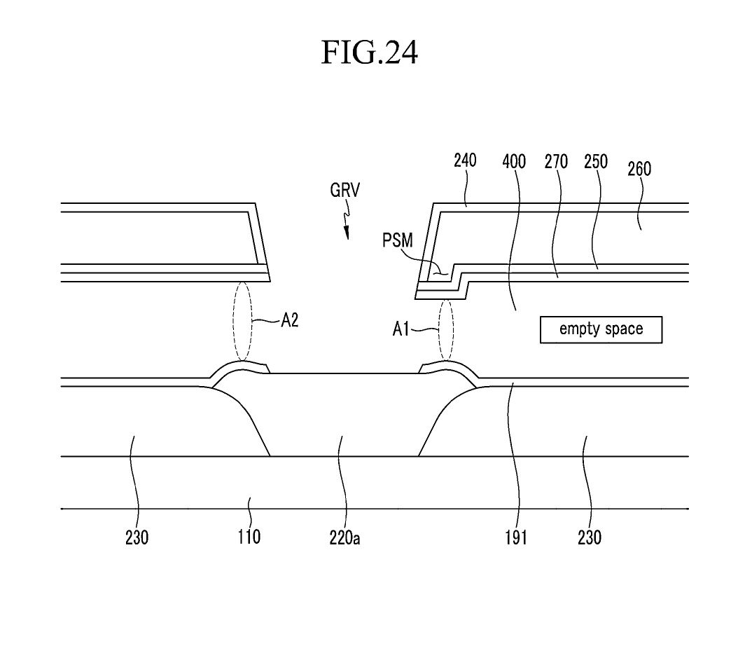

Referring to FIG. 24, the sacrificial layer 300 is removed through the groove GRV by, for example, an O2 ashing process or a wet etching method. A microcavity layer 400 having liquid crystal injection holes A1 and A2 is thereby formed. The microcavity layer 400 is an empty space where the sacrificial layer 300 is removed. The liquid crystal injection holes A1 and A2 may be formed along the direction parallel to the signal line connected to one terminal of the thin film transistor.

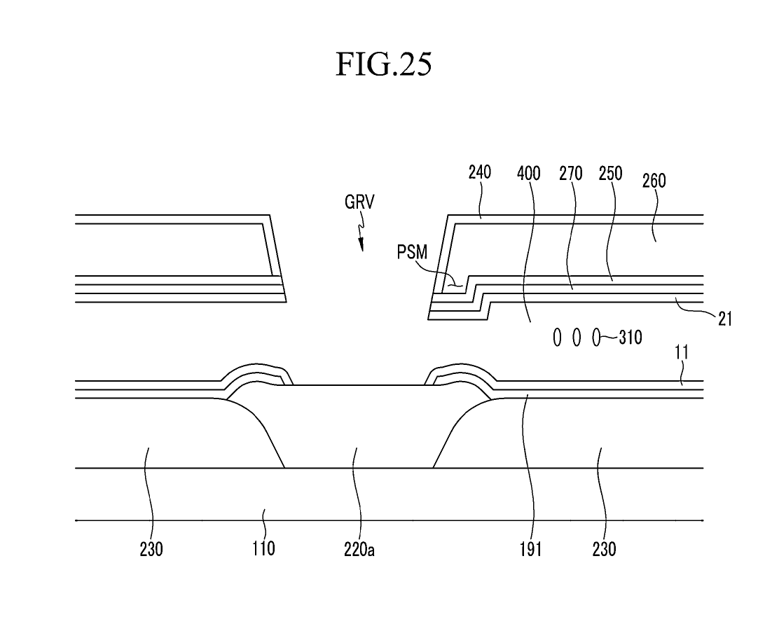

Referring to FIG. 25, an alignment material is injected through the groove GRV and the liquid crystal injection holes A1 and A2 to form alignment layers 11 and 21 on the pixel electrode 191 and the common electrode 270. A bake process is performed after injecting the alignment material through the liquid crystal injection holes A1 and A2. At this time, the alignment layer is formed while the solvent of the alignment material is volatilized and the remaining solids are gathered at the smaller opening, i.e. under the PSM and over the light blocking member 220a.

Next, the liquid crystal molecules 310 are injected into the microcavity layer 400 through the groove GRV and the liquid crystal injection holes A1 and A2 via an inkjet or other suitable method. Here, the alignment layers 11 and 21 are formed such that the size of the liquid crystal injection holes A1 and A2 may be reduced compared with the liquid crystal injection hole that is initially formed.

Next, a capping layer 280 (shown in FIG. 16) covering the upper surface and the side surface of the supporting member 260 is formed. At this time, the capping 280 covers the liquid crystal injection holes A1 and A2 of the microcavity layer 400 exposed through the groove GRV.

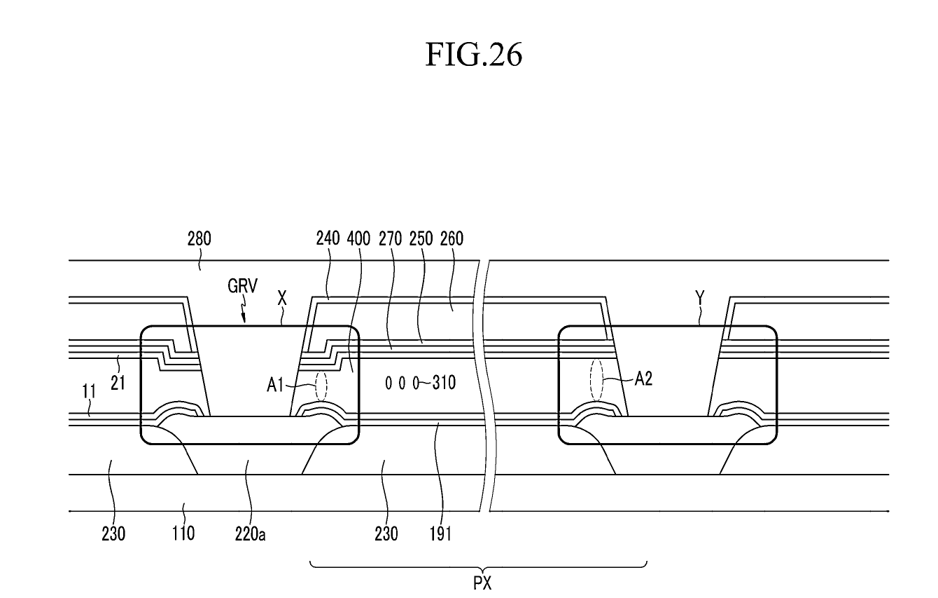

FIG. 26 is a cross-sectional view taken along the line III-III of FIG. 1 to explain a liquid crystal display according to an exemplary embodiment of the present invention. The exemplary embodiment shown in FIG. 26 is structurally similar to the exemplary embodiment shown in FIG. 17. However, in one pixels PX, the structure of the microcavity layers 400 facing each other is symmetric with respect to the light blocking member 220a. As shown in FIG. 26, the first structure X is symmetric and the second structure Y is symmetric. However, in the present exemplary embodiment, the first structure X and the second structure Y are repeatedly arranged according to the vertical direction, and one microcavity layer 400 has the liquid crystal injection holes A1 and A2 corresponding to a right portion of the first structure X and a left portion of the second structure Y, so that its openings are asymmetric with respect to one microcavity layer 400. Accordingly, in the case of the present exemplary embodiment, in one microcavity layer 400, the shape of both ends of the microcavity layer 400 corresponding to the liquid crystal injection holes A1 and A2 is asymmetric, such that capillary forces act preferentially at hole A2 of one side.

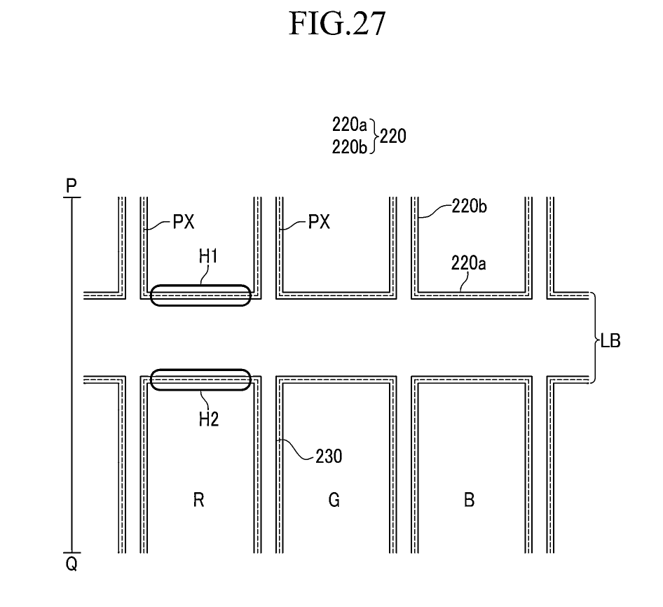

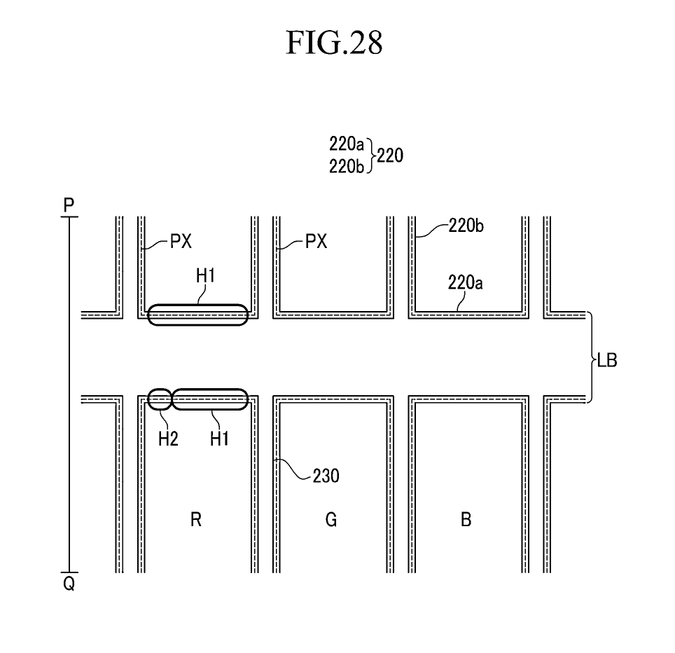

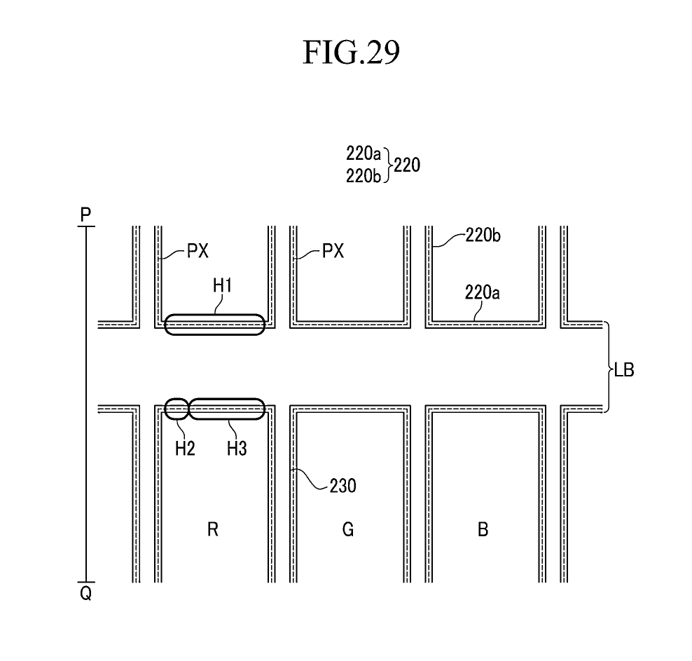

FIG. 27 is a top plan view viewing a liquid crystal display according to an exemplary embodiment of the present invention from a position P to a position Q of FIG. 16 for explanation. FIG. 28 and FIG. 29 are top plan views to schematically explain a liquid crystal display according to an exemplary embodiment of the present invention.

Referring to FIG. 27, a light blocking member 220 is formed at a light blocking region LB corresponding to the separation space of the organic layer 230. In the present exemplary embodiment, the first region H1 and the second region H2 are respectively positioned at the upper end and the lower end with respect to the light blocking region LB. The first region H1 indicates the portion in which that the first liquid crystal injection hole A1 is positioned and the second region H2 indicates the portion in which that the second liquid crystal injection hole A2 is positioned, as shown in FIG. 16.

Here, the first region H1 substantially corresponds to one entire transverse edge of the pixel PX or one entire edge of the unit micro cavity layer 400. However, if the first region H1 is formed in the most region of the transverse edge of the pixel PX, the remaining solid while the alignment material is dried may block the liquid crystal injection hole.

To prevent this problem, a further exemplary embodiment will be described with reference to FIG. 28.

Referring to FIG. 28, in the present exemplary embodiment, the portion corresponding to the first region H1 may be only partially formed at the transverse edge of the pixel PX or one edge of the unit micro cavity layer 400.

Also, the second region H2 that one end of the micro cavity layer 400 has the height h2 is formed at the portion adjacent to the first region H1. The solid remaining after the alignment material is dried is concentrated to the first region H1 among the transverse edge of the pixel PX.

Accordingly, a possibility that the liquid crystal injection hole may be partially blocked is reduced.

A variation exemplary embodiment of the exemplary embodiment of FIG. 28 will be described with reference to FIG. 29.

Referring to FIG. 29, the portion corresponding to the first region H1 is formed according to the transverse edge of the pixel PX at the portion of the transverse edge of the pixel PX or one edge of the unit micro cavity layer 400, and the third region H3 where one end of the micro cavity 400 has the height that is higher than the height h1 and is smaller than the height h2 is formed at the portion adjacent to the first region H1.

FIG. 30 is a perspective view of a microcavity layer shape to explain a liquid crystal display according to an exemplary embodiment.

FIG. 30 indicates the unit micro cavity layer 400 in FIG. 5, and the width w1 of the liquid crystal injection hole A1 of one side is smaller than the width w2 of the liquid crystal injection hole A2 of the other side.

Accordingly, the cross-section of the liquid crystal injection hole A1 having the small width is smaller than the cross-section of the liquid crystal injection hole A2 having the large width.

Accordingly, the capillary force may strongly act to the liquid crystal injection hole A1 of one side in the process that the alignment material is dried in the microcavity layer 400.

The exemplary embodiment described in FIGS. 1 to 5 is one exemplary embodiment for the cross-section of the microcavity layer in which the liquid crystal injection hole is positioned in the microcavity layer 400 to be smaller than the cross-section of the microcavity layer positioned near the liquid crystal injection hole, and the exemplary embodiment described in FIG. 30 is also an exemplary embodiment that the cross-section of the microcavity layer in which the liquid crystal injection hole is positioned is smaller than the cross-section of the microcavity layer positioned near the liquid crystal injection hole.

Accordingly, in the present exemplary embodiment, to act the capillary force strongly at one side, to design the structure that the cross-section of the microcavity layer in which the liquid crystal injection hole is positioned at one side is smaller than the cross-section of the microcavity layer positioned near the liquid crystal injection hole or the liquid crystal injection hole at the other side, the width of the liquid crystal injection hole of one side may be small or the height of the liquid crystal injection hole may be low.

However, the method reducing the width or the height of the liquid crystal injection hole is not limited to the described method and various variations may be designed.

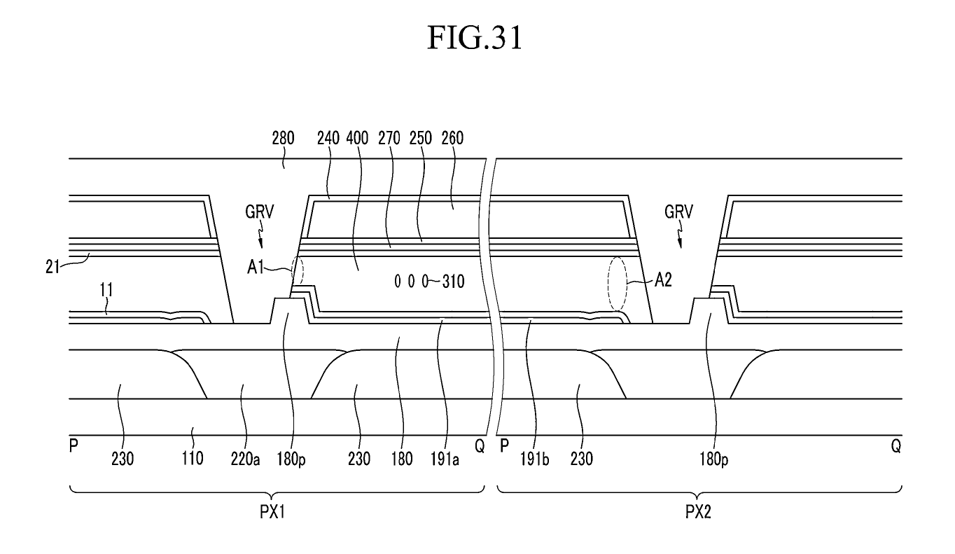

FIG. 31 is a cross-sectional view of a liquid crystal display according to an exemplary embodiment of the present invention.

FIG. 31 is the cross-sectional view taken along the line III-III of FIG. 1, however, differently from FIG. 4, the width that the transverse light blocking member 220a overlap each edge of the organic layer 230 adjacent thereto is the substantially same.

In the present exemplary embodiment, similarly to the exemplary embodiment described in FIG. 1 to FIG. 4, the cross-section of the microcavity layer in which the first liquid crystal injection hole A1 is positioned is smaller than the cross-section of the microcavity layer 400 in which the second liquid crystal injection hole A2 is positioned.

The liquid crystal display according to the present exemplary embodiment further includes a planarization layer 180 positioned on the organic layer 230 and the light blocking member 220. To form the different cross-sections of the liquid crystal injection holes of both sides, in the present exemplary embodiment, a thickness of the planarization layer 180 positioned under the liquid crystal injection hole may be controlled.

In detail, referring to FIG. 31, the thickness of the first portion of the planarization layer 180 positioned under the first liquid crystal injection hole A1 is thicker than the thickness of the second portion of the planarization layer 180 positioned under the second liquid crystal injection hole A2.

In the first portion of the planarization layer 180, a protrusion 180p is formed in a direction that the first liquid crystal injection hole A1 is positioned.

When forming the planarization layer 180, the protrusion 180p is formed by using a minute slit exposing method such that a separate process is not added.

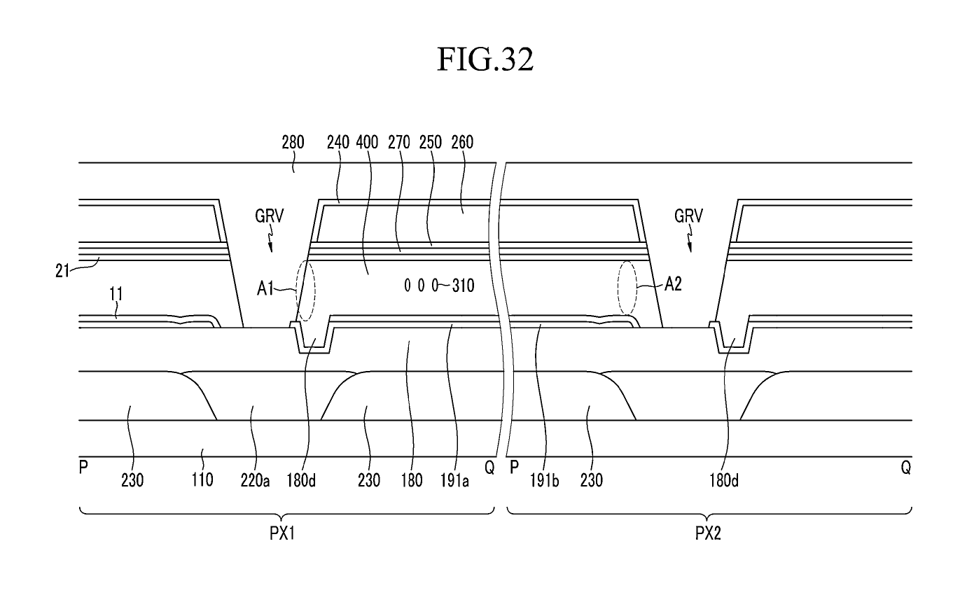

FIG. 32 is a cross-sectional view of a liquid crystal display according to an exemplary embodiment of the present invention.

FIG. 32 is the same as most constitutions of the exemplary embodiment described in FIG. 31, however a recess portion 180d is formed in the planarization layer 180 instead of the protrusion 180p.

Referring to FIG. 32, the thickness of the first portion of the planarization layer 180 positioned under the first liquid crystal injection hole A1 is thinner than the thickness of the second portion of the planarization layer 180 positioned under the second liquid crystal injection hole A2.

In the first portion of the planarization layer 180, a depressed 180d is formed in a direction opposite to the direction that the first liquid crystal injection hole A1 is positioned.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of Symbols >

| | | | |
|---|---|---|---|
| 220 | light blocking member | 230 | organic layer |
| 191 | pixel electrode | 300 | sacrificial layer |
| 250 | overcoat | 260 | supporting member |
| 270 | common electrode | 400 | microcavity layer |

What is claimed is:

1. A display panel, comprising:
a substrate;
an electrode disposed on the substrate; and
a supporting member disposed on the electrode;
the supporting member shaped to form a cavity between the supporting member and the electrode, wherein the cavity has a first opening at one end of the supporting member and a second opening at an opposite end of the supporting member, the first opening being positioned over the electrode; and
wherein a cross-sectional area of the first opening is smaller than a cross-sectional area of the second opening.

2. The display panel of claim 1, wherein the supporting member has a first height from the electrode at the first opening, and a second height from the electrode at the second opening; and
wherein the first height is less than the second height.

3. The display panel of claim 1, further comprising a black matrix disposed on the substrate, wherein the black matrix is a first black matrix positioned on the substrate and under the first opening, the first black matrix having an upper surface facing the first opening;
wherein the display panel further comprises a second black matrix positioned on the substrate and under the second opening, the second black matrix having an upper surface facing the second opening; and
wherein the upper surface of the first black matrix has a first height at the first opening, the upper surface of the second black matrix has a second height at the second opening, and the first height is greater than the second height.

4. The display panel of claim 3, wherein the first height is at least approximately 0.8 μm greater than the second height.

5. The display panel of claim 4, wherein the first height is approximately 1.3 μm greater than the second height.

6. The display panel of claim 3, wherein at least one of the first black matrix and the second black matrix extends under only a portion of its respective opening.

7. The display panel of claim 6, wherein the at least one of the first black matrix and the second black matrix has a width that is less than or equal to about 80% of a width of its respective opening.

8. The display panel of claim 3, wherein at least one of the upper surface of the first black matrix and the upper surface of the second black matrix has multiple heights.

9. The display panel of claim 8, wherein a difference between two of the multiple heights is approximately 0.5 μm.

10. The display panel of claim 9, wherein one of the two of the multiple heights is approximately 0.8 μm from an upper surface of an organic layer adjacent to the first and second black matrices, and the other of the two of the multiple heights is approximately 1.3 μm from the upper surface of the organic layer.

11. The display panel of claim 8, wherein the multiple elevations include a first elevation and a second elevation;
wherein the first elevation is greater than the second elevation; and
wherein a portion of the at least one of the upper surface of the first black matrix and the upper surface of the second black matrix having the first elevation has a width less than about 80% of a width of the portion of the at least one of the upper surface of the first black matrix and the upper surface of the second black matrix having the second elevation.

12. A display panel, comprising:
a substrate;
an electrode disposed on the substrate; and
a supporting member disposed on the electrode, the supporting member shaped to form a cavity between the supporting member and the electrode;
wherein the supporting member has a first portion positioned proximate to one end of the cavity and a second portion positioned at a central portion of the cavity; and
wherein the first portion is positioned at a first distance from the electrode, and the second portion is positioned at a second distance from the electrode, the second distance being greater than the first distance.

13. The display panel of claim 12, further comprising a first light blocking member positioned under the first portion of the supporting member and proximate to the one end of the cavity, and a second light blocking member positioned under another end of the cavity and proximate to the second portion of the supporting member;
wherein the first portion is positioned at a first height from a surface of the first light blocking member that faces the first portion, and the second portion is positioned at a second height from a surface of the second light blocking member that faces the second portion, the second height being greater than the first height.

14. The display panel of claim 13, wherein a smallest distance between the surface of the first light blocking member and the first portion is less than a smallest distance between the surface of the second light blocking member and the second portion.

15. The display panel of claim 13, wherein at least one of the first light blocking member and the second light blocking member extends under only a portion of its respective end of the cavity.

16. The display panel of claim 15, wherein the at least one of the first light blocking member and the second light blocking member has a width that is less than or equal to about 80% of a width of its respective end of the cavity.

17. The display panel of claim 13, wherein at least one of the surface of the first light blocking member and the surface of the second light blocking member has multiple elevations.

18. The display panel of claim 17, wherein a difference between two of the multiple elevations is approximately 0.5 μm.

19. The display panel of claim 18, wherein one of the two of the multiple elevations has a height approximately 0.8 μm from an upper surface of an organic layer adjacent to the first and second light blocking members, and the other of the two of the multiple elevations has a height approximately 1.3 μm from the upper surface of the organic layer.

20. The display panel of claim 17, wherein the multiple elevations include a first elevation and a second elevation;
wherein the first elevation is greater than the second elevation; and
wherein a portion of the at least one of the surface of the first light blocking member and the surface of the second light blocking member having the first elevation has a width less than about 80% of a width of the portion of the at least one of the surface of the first light blocking member and the surface of the second light blocking member having the second elevation.

21. The display panel of claim 12 further comprising a first light blocking member positioned under the first portion of the supporting member, wherein the first portion has a depression formed therein, the depression positioned over the first light blocking member.

22. A method of manufacturing a display panel, comprising:
forming an electrode on a substrate;
forming a sacrificial layer on the electrode;
patterning a depression in the sacrificial layer;
forming a supporting member on the sacrificial layer and the depression;
removing a portion of the supporting member that is positioned on the depression, so as to form a groove exposing the sacrificial layer; and
removing the sacrificial layer through the groove, so as to form a cavity between the supporting member and the electrode, the cavity configured to hold a liquid therein.

23. The method of claim 22 wherein the patterning a depression further comprises patterning the depression using a half tone mask or a slit mask.

24. The method of claim 22, further comprising forming adjacent first and second organic layers and a light blocking member on the substrate, the light blocking member positioned between the adjacent organic layers so as to overlap ends of both the first and second organic layers.

25. The method of claim 24:
wherein the patterning further comprises patterning the depression over the light blocking member, so that the supporting member has a first portion positioned in the depression and a second portion positioned outside the depression;
wherein the removing a portion of the supporting member further comprises removing part of the first portion of the supporting member so as to leave a remaining portion of the supporting member in the depression; and
wherein the remaining portion of the supporting member is positioned at a first distance from the electrode, and the second portion of the supporting member is positioned at a second distance from the electrode, the second distance being greater than the first distance.

26. The method of claim 25, wherein the removing the sacrificial layer further comprises removing the sacrificial layer so as to form a first cavity having an opening at least partially defined by the remaining portion of the supporting member, and so as to form a second cavity having an opening at least partially defined by the second portion of the supporting member, the openings of the first and second cavities both being positioned over the light blocking member.

27. The method of claim 24 wherein, at at least one of the ends, the light blocking member overlaps only a part of an end of the respective organic layer.

28. The method of claim 27 wherein, at at least one of the ends, the light blocking member overlapping the part of the end of the respective organic layer has a width that is less than or equal to about 80% of a width of a corresponding end of the cavity.

29. The method of claim 24 wherein, at a corresponding end of the cavity, the light blocking member has multiple elevations.

30. The method of claim 29, wherein a difference between two of the multiple elevations is approximately 0.5 μm.

31. The method of claim 30, wherein one of the two of the multiple elevations has a height approximately 0.8 μm from an upper surface of an organic layer adjacent to the light blocking member, and the other of the two of the multiple elevations has a height approximately 1.3 μm from the upper surface of the organic layer.

32. The method of claim 29, wherein the multiple elevations include a first elevation and a second elevation;
wherein the first elevation is greater than the second elevation; and
wherein a portion of the light blocking member having the first elevation has a width less than about 80% of a width of a portion of the light blocking member having the second elevation.

33. A display panel, comprising:
a substrate;
a first electrode disposed on the substrate;
a black matrix formed on the substrate; and
a supporting member disposed on the substrate over the first electrode and the black matrix, the supporting member shaped to form a cavity between the pixel electrode and the supporting member, the cavity having a narrow portion positioned over the black matrix, the narrow portion having a smaller cross-sectional area than a remainder of the cavity.

34. The display panel of claim 33, wherein the supporting member has a first height from the first electrode at the narrow portion of the cavity, and a second height from the first electrode at the remainder of the cavity; and
wherein the first height is less than the second height.

35. The display panel of claim 33, wherein the black matrix is a first black matrix positioned on the substrate and under one end of the cavity, the first black matrix having an upper surface facing the cavity;
wherein the display panel further comprises a second black matrix positioned on the substrate and under another end of the cavity, the second black matrix having an upper surface facing the cavity; and
wherein the upper surface of the first black matrix has a first height at the one end of the cavity, the upper surface of the second black matrix has a second height at the another end of the cavity, and the first height is greater than the second height.
